(19) United States
(12) Patent Application Publication
(10) Pub. No.: US 2024/0307982 A1
(43) Pub. Date: Sep. 19, 2024

(54) TABLE SAW

(71) Applicant: MAKITA CORPORATION, Anjo-shi (JP)

(72) Inventors: Ryota KITAOKA, Anjo-shi (JP); Toshiyuki KANI, Anjo-shi (JP)

(73) Assignee: MAKITA CORPORATION, Anjo-shi (JP)

(21) Appl. No.: 18/582,825

(22) Filed: Feb. 21, 2024

(30) Foreign Application Priority Data
Mar. 14, 2023 (JP) 2023-039410
Jun. 28, 2023 (JP) 2023-105723

(51) Int. Cl. B23D 45/06; B27B 5/36

(52) U.S. Cl. CPC B23D 45/062; B27B 5/36

(57) ABSTRACT

A table saw has a table on which the workpiece is placed. The table saw has a main body located below the table and equipped with a motor. The table saw has a cutting blade connected to the motor and penetrating the table in an up-down direction. The table saw has a guide mechanism for tilting the cutting blade along with the main body with respect to the table. The guide mechanism moves the center of the cutting blade downward and away from the table as the upper end of the cutting blade is moved closer to the table, and to the right (second side) opposite to the left (first side) to which the upper end moves.

### CROSS-REFERENCE TO RELATED APPLICATIONS

This application claims priority to Japanese patent application serial numbers 2023-039410 filed Mar. 14, 2023 and 2023-105723 filed Jun. 28, 2023, the contents of which are incorporated herein by reference in their entirety for all purposes.

### BACKGROUND

The present invention relates to a table saw used for cutting workpiece, such as a wood.

This type of table saw has a table on which a workpiece is placed and a disk-shaped cutting blade (circular saw blade) that projects upward through the table. The cutting blade is rotatably supported to a main body, which is arranged below the table. The main body is provided with a motor as a drive source to rotate the cutting blade and an output shaft to which the cutting blade is integrally attached. The cutting blade integrally rotates with the output shaft by activating the motor to rotate the output shaft around its axis. A workpiece is fed along the table toward the cutting blade, which protrudes upward from a top surface of the table and rotates. This allows the cutting blade to cut into the workpiece and cut the workpiece.

As described in prior arts, the main body is movable in an up-down direction with respect to the table. The cutting blade protrusion height (cutting depth) of the cutting blade protruding upward from the table top surface, may be changed by moving the main body in the up-down direction. The cutting blade protrusion height is a length in the up-down direction perpendicular to the table top surface from an upper end of the cutting blade to the table top surface. A length of cutting blade protrusion indicates a length in a direction parallel to the cutting blade from the upper end of the cutting blade to the table. By increasing the cutting blade protrusion height, for example, thicker workpieces can be cut. By lowering the cutting blade protrusion height, for example, grooving can be performed on the workpiece. Furthermore, the main body can be tilted in a left-right direction relative to the table. By tilting the main body in the left-right direction, a tilt angle of the cutting blade with respect to a plane perpendicular to the table can be changed. By setting the cutting blade at a right angle to the table (tilt angle to the plane perpendicular to the table is 0°), the workpiece can be cut with a so-called right-angle cut. By tilting the cutting blade with respect to the plane perpendicular to the table, the workpiece can be cut with a so-called bevel cut. In the right-angle cut position (hereinafter referred to as “right-angle position”), the output shaft extends horizontally. Therefore, the output shaft can be moved upward to the underside of the table or near the underside of the blade edge plate to increase the blade protrusion height.

On the other hand, in the bevel cut position (“bevel position”), the output shaft is inclined toward either the left or right side of the table. Therefore, when the main body is tilted from the right-angle position with a greater blade protrusion height (with a longer length of blade protrusion) to the bevel position, the output shaft may interfere with the underside of the table or the underside of the blade edge plate. Particularly, if a thicker cutting blade for groove cutting is to be attached to the output shaft, the output shaft needs to be extended longer. Therefore, the output shaft easily interferes with the underside of the table or the underside of the blade edge plate in the bevel position. It is thus necessary to control the length of blade protrusion so that the output shaft does not interfere with the underside of the table or the underside of the blade edge plate. However, if the length of blade protrusion is reduced considering the case of bevel position, it is not possible to obtain a sufficient length of blade protrusion for cutting thick workpiece in a right-angle position.

Therefore there has long been a need for a table saw capable of automatically controlling the length of blade protrusion in accordance with the tilt angle of the cutting blade.

### SUMMARY

A table saw according to one aspect of the present disclosure includes a table on which the workpiece is placed. The table saw has a main body disposed below the table and equipped with a motor. The table saw has a cutting blade connected to the motor and penetrating the table in an up-down direction. The table saw has a movable mechanism to allow the cutting blade to move along with the main body with respect to the table. The movable mechanism can adjust a height of the main body and an angle of the main body with respect to the table. The movable mechanism has a guide mechanism that can tilt the cutting blade along with the main body with respect to the table. The guide mechanism moves a center of the cutting blade downward and away from the table as an upper end of the cutting blade is moved closer to the table, so that the upper end of the cutting blade moves to a first side while the center of the cutting blade to a second side opposite to the first side.

Therefore, as the tilt angle of the cutting blade with respect to the plane perpendicular to the table increases, the upper end of the cutting blade approaches the table. As the upper end of the cutting blade approaches the table, the cutting blade shifts toward the second side opposite to the tilting direction. As a result, a length from the upper end of the cutting blade to the table in the direction parallel to the cutting blade, i.e., the length of blade protrusion is reduced. When the tilt angle of the cutting blade with respect to the plane perpendicular to the table increases, a length of blade protrusion can be automatically controlled; therefore, prevents the output shaft that supports the cutting blade rotatably from interfering with an underside of the table during a bevel cutting.

Moreover, the table saw is configured to shift the cutting blade to the second side while the upper end of the cutting blade is tilted to the first side. This configuration allows the cutting blade to be tilted without shifting an intersection area (virtual tilting axis) where the cutting blade and an extension surface the table intersect. Therefore, for example, a distance between the intersection area and a rip fence (guide ruler) positioned on the table can be kept constant. As a result, the workpiece is cut at a constant width with the workpiece placed against the rip fence, both in the case of a right-angle cut or a bevel cut.

### BRIEF DESCRIPTION OF THE DRAWINGS

FIG. 1 is a perspective view of a table saw according to a first example of the present disclosure.

FIG. 2 is a perspective view of the table saw with the blade edge plate removed.

FIG. 3 is a left side view of the table saw in a right-angle position and with the maximum length of blade protrusion.

FIG. 4 is a left side view of the table saw in the right-angle position and with the minimum length of blade protrusion.

FIG. 5 is a front view of the table saw in the right-angle position and with the maximum length of blade protrusion.

FIG. 6 is a cross-sectional view taken along a line VI-VI in FIG. 3.

FIG. 7 is a cross-sectional view taken along a line VII-VII in FIG. 3.

FIG. 8 is a cross-sectional view taken along a line VIII-VIII in FIG. 4.

FIG. 9 is a vertical sectional view corresponding to the cross-sectional view taken along a line VII-VII in FIG. 3 in a bevel position at a tilt angle of 30°.

FIG. 10 is a vertical sectional view corresponding to the cross-sectional view taken along a line VII-VII in FIG. 3 in the bevel position at a tilt angle of 45°.

FIG. 11 is an enlarged view of a section XI in FIG. 6.

FIG. 12 is an enlarged view of the section XI in FIG. 6 in the bevel position at a tilt angle of 30°.

FIG. 13 is an enlarged view of the section XI in FIG. 6 in the bevel position at a tilt angle of 45°.

FIG. 14 is a cross-sectional view taken along a line XIV-XIV in FIG. 3.

FIG. 15 is an enlarged view of the section XV in FIG. 14.

FIG. 16 is a top view of the table saw with the blade edge plate removed.

FIG. 17 is a top view illustrating a length of retraction of the cutting blade corresponding to the tilt angle of the cutting blade.

FIG. 18 is a left side view of the table saw according to a second example of the present disclosure in the right-angle position and with the maximum length of blade protrusion.

FIG. 19 is a cross-sectional view taken along a line XIX-XIX in FIG. 18.

FIG. 20 is a perspective view of a table saw according to an example of the present disclosure, illustrating the table saw in a right-angle position and with the height restriction mechanism activated.

FIG. 21 is a left side view of the table saw in the right-angle position and with the height restriction mechanism activated.

FIG. 22 is a cross-sectional view taken along a line XXII-XXII in FIG. 21.

FIG. 23 is a perspective view of a stopper shaft shifted to a restricted position.

FIG. 24 is an exploded perspective view of the stopper shaft.

FIG. 25 is a front side view of a base front side.

FIG. 26 is an enlarged left side view of a section XXVI in FIG. 21.

FIG. 27 is a perspective view of the table saw in the right-angle position and with the height restriction mechanism released.

FIG. 28 is a left side view of the table saw in the right-angle position and with the height restriction mechanism released.

FIG. 29 is a cross-sectional view taken along a line XXIX-XXIX in FIG. 28.

FIG. 30 is a perspective view of the stopper shaft shifted to a release position.

FIG. 31 is an enlarged left side view of a section XXXI in FIG. 28.

FIG. 32 is a perspective view of the table saw in a bevel position.

FIG. 33 is a vertical sectional view of the table saw in the bevel position, corresponding to the cross-sectional view taken along a line XXII-XXII in FIG. 21.

FIG. 34 is a left side view of the table saw in the bevel position corresponding to the section XXVI in FIG. 21.

FIG. 35 is a left side view of the table saw in the bevel position corresponding to the section XXVI in FIG. 21, with the restriction maintaining mechanism activated.

### DETAILED DESCRIPTION

According to another aspect of the present disclosure, a guide mechanism includes a first link connecting the table to the main body. The guide mechanism includes a second link that is disposed on a first side with respect to the first link and connects the table and the main body. By using two links such as the first link and the second link, the cutting blade can be tilted in a different trajectory from a rotation around an intersection area where the cutting blade and an extension surface of the table intersect. Therefore, when tilting the cutting blade, the cutting blade can be automatically shifted so that the length of blade protrusion is restricted.

According to another aspect of the present disclosure, the table saw has a first body-side shaft that rotatably connects the first link to the main body. The table saw has a first table-side shaft that rotatably connects the first link to the table. The table saw has a second body-side shaft that rotatably connects the second link to the main body. The table saw has a second table-side shaft that connects the second link to the table. The first body-side shaft is located farther from the intersection area of the cutting blade and the table than the first table-side shaft. The second body-side shaft is located farther from the intersection area than the second table-side shaft.

When the first link rotates around the first table-side shaft, the travel distance of the first body-side shaft relative to the intersection area increases. When the second link rotates around the second table-side shaft, the travel distance of the second body-side shaft relative to the intersection area increases. Therefore, the movement of the cutting blade in the direction parallel to the cutting blade can be made larger and more precise. This allows the cutting blade to move precisely and smoothly so that the length of blade protrusion decreases as the tilt angle increases.

According to another aspect of the present disclosure, the table saw has a first body-side shaft that rotatably connects the first link to the main body. The table saw has a first table-side shaft that rotatably connects the first link to the table. The table saw has a second body-side shaft that rotatably connects the second link to the main body. The table saw has a second table-side shaft that rotatably connects the second link to the table. The distance between the first body-side shaft and the second body-side shaft is greater than the distance between the first table-side shaft and the second table-side shaft.

The first link rotates around the first table-side shaft and the second link rotates around the second table-side shaft. Because the distance between the first body-side shaft and the second body-side shaft is greater than the distance between the first table-side shaft and the second table-side shaft, the first body-side shaft and second body-side shaft more easily move so as to mutually rotate than to move mutually parallel. This prevents the main body including the cutting blade from moving parallel to each other in the left-right direction and allows the cutting blade and the extension surface of the table to remain intersected in the intersection area.

According to another aspect of the present disclosure, the second link is longer than the first link. Therefore, as the cutting blade is tilted toward the first side, the second body-side shaft moves away from the intersection area. This allows the upper end of the cutting blade to approach the intersection area as the cutting blade is tilted toward the first side. As a result, the length of blade protrusion may be decreased as the tilt angle of the cutting blade increases.

According to another aspect of the present disclosure, at least a part of the first link or the second link is disposed between the cutting blade and the motor when viewed from a direction perpendicular to the tilting direction of the cutting blade. At least a part of the first or second link is disposed between the heavy motor and the cutting blade. Therefore, the stability of the posture of the main body, which is supported by the guide mechanism in a tiltable and movable manner, can be enhanced.

The table saw according to another aspect of the present disclosure has a lifting shaft that is supported by the table and guides the main body in a direction parallel to the cutting blade. At least a part of the first link or the second link is disposed between the cutting blade and the lifting shaft as viewed from a direction perpendicular to the tilting direction of the cutting blade. The lifting shaft and the guide mechanism are moveable to approach in a direction perpendicular to the tilting direction of the cutting blade. Therefore, when an external force acts on the cutting blade, the rigidity of the main body can be maintained. Even when the length of blade protrusion is changed by the lifting shaft, the tilting and movement of the cutting blade by the guide mechanism can be made to follow the same path.

According to another aspect of the present disclosure, the guide mechanism has a guide member that is supported by the table and guides the main body in the direction to be moved by the first and second links. The motor is disposed between the first link and the guide member in the front-back direction along which the cutting blade extends. Therefore, the first link and the guide member can be provided with the heavy motor interposed therebetween. Therefore, the stability of the posture of the main body supported by the guide mechanism may be enhanced not only in the tilting direction but also in the front-back direction.

The table saw according to another aspect of the present disclosure has a lifting shaft that is supported by the table and guides the main body in a vertical direction. The guide mechanism has a guide member that is supported by the table and guides the main body in the direction to move the main body by the first and second links. The lifting shaft is disposed between the first link and the guide member in the front-back direction along which the cutting blade extends. Therefore, the first link and the guide member can be provided with the lifting shaft disposed therebetween. Thus, the structure to support the main body upwardly and downwardly movably in a direction parallel to the cutting blade can be supported not only by the lifting shaft but also by the front and rear guide mechanisms. This may increase the stability of the tilting trajectory that tilts the main body to the left or right.

The table saw according to another aspect of the present disclosure has a link support that is releasably fixed to the table and connected to the links. The link support is formed with an elongated hole penetrating in the up-down direction through which a screw can be fitted, and the screw fitted in the elongated hole can be tightened to the table from above. Therefore, the screw can be loosened or tightened to the table from above. This allows the position of the cutting blade relative to the table to be easily adjusted by moving the link support.

According to another aspect of the present disclosure, the length of protrusion of the cutting blade in the direction parallel to the cutting blade decreases as the tilt angle of the cutting blade with respect to the plane perpendicular to the table increases. The length of protrusion decreases more as the tilt angle decreases, and the length of decrease reduces less as the tilt angle increases. Therefore, when the tilt angle of the cutting blade with respect to the plane perpendicular to the table is near 0°, the length of blade protrusion decreases significantly. Thus, when the cutting blade is in a right-angle position with a tilt angle of 0°, the length of blade protrusion can be sufficiently increased. When the cutting blade is inclined even slightly, the output shaft supporting the cutting blade can be quickly retracted downward to avoid interference with the table or other objects. Further, the output shaft can be sufficiently retracted downward from the table when the tilt angle of the cutting blade is small. Therefore, the decrease in the length of blade protrusion when the tilt angle of the cutting blade is large can be controlled. This allows the necessary height of the blade protrusion to be secured even when the tilt angle of the cutting blade is large.

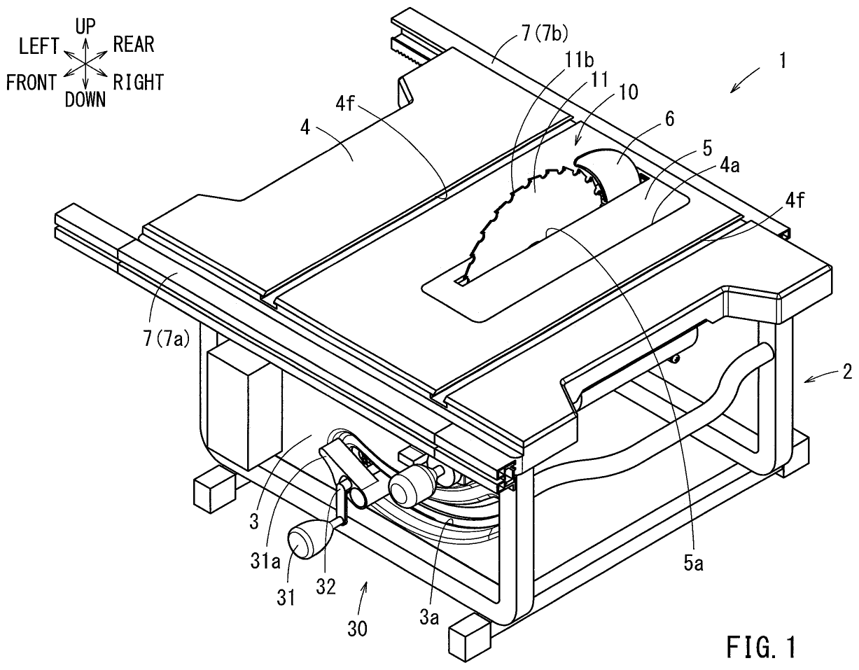

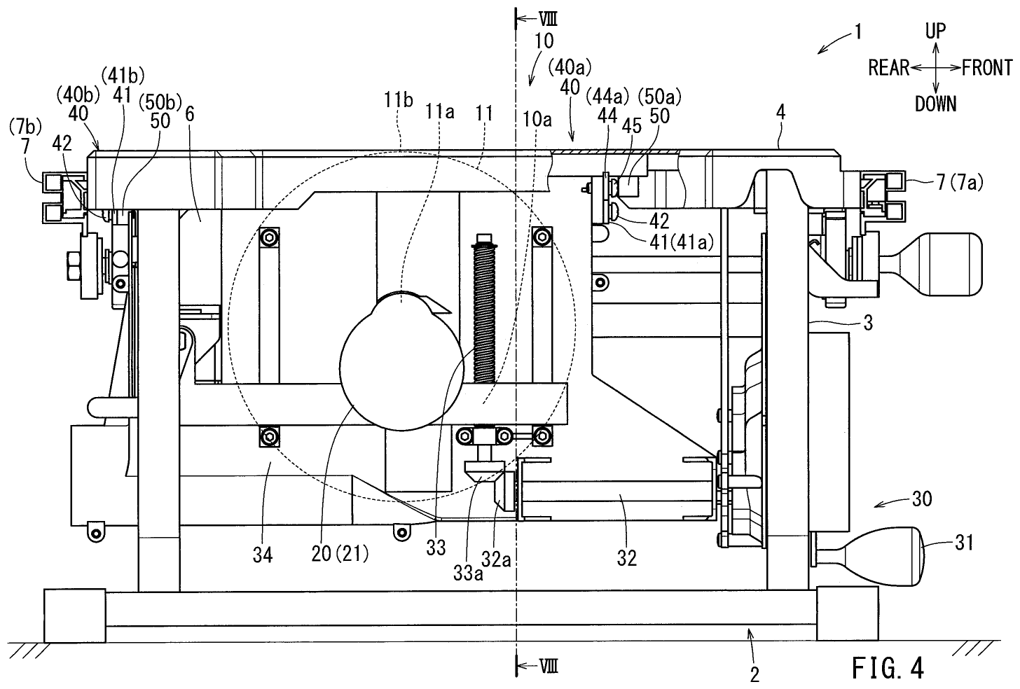

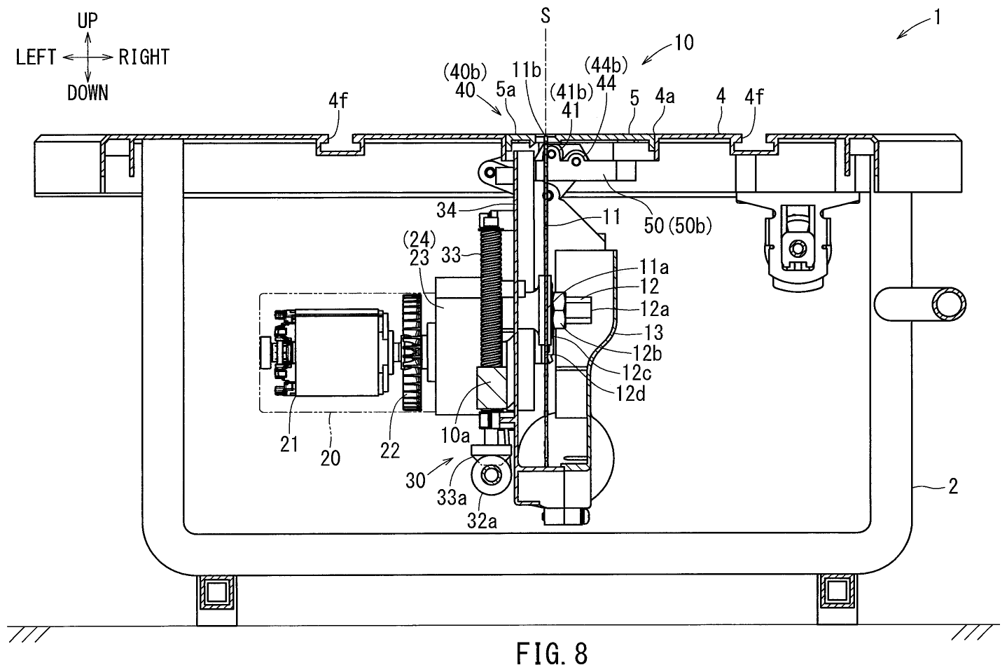

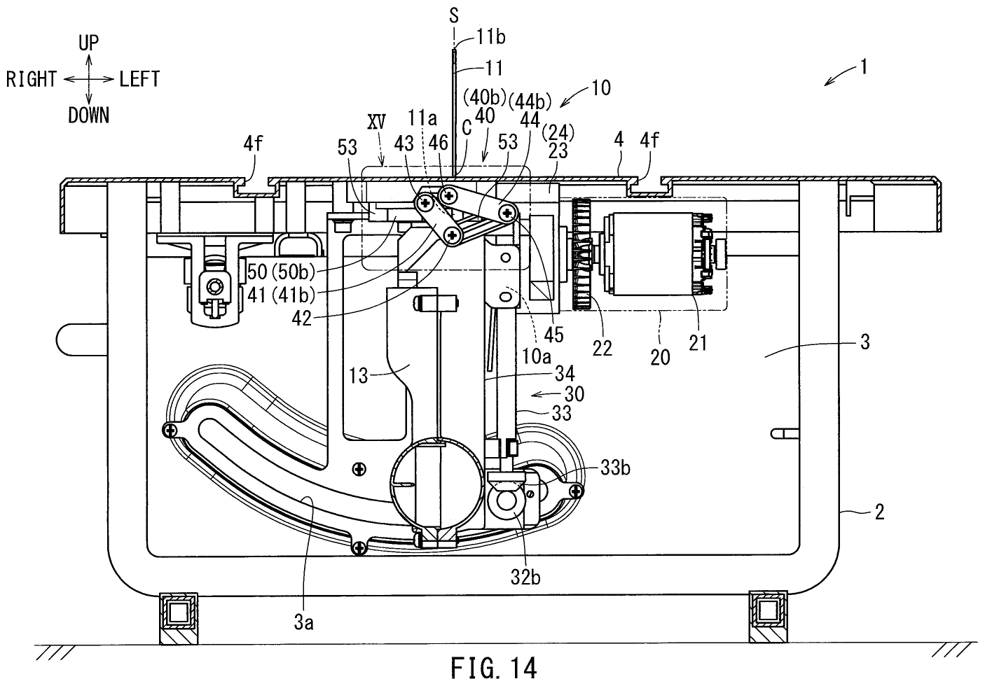

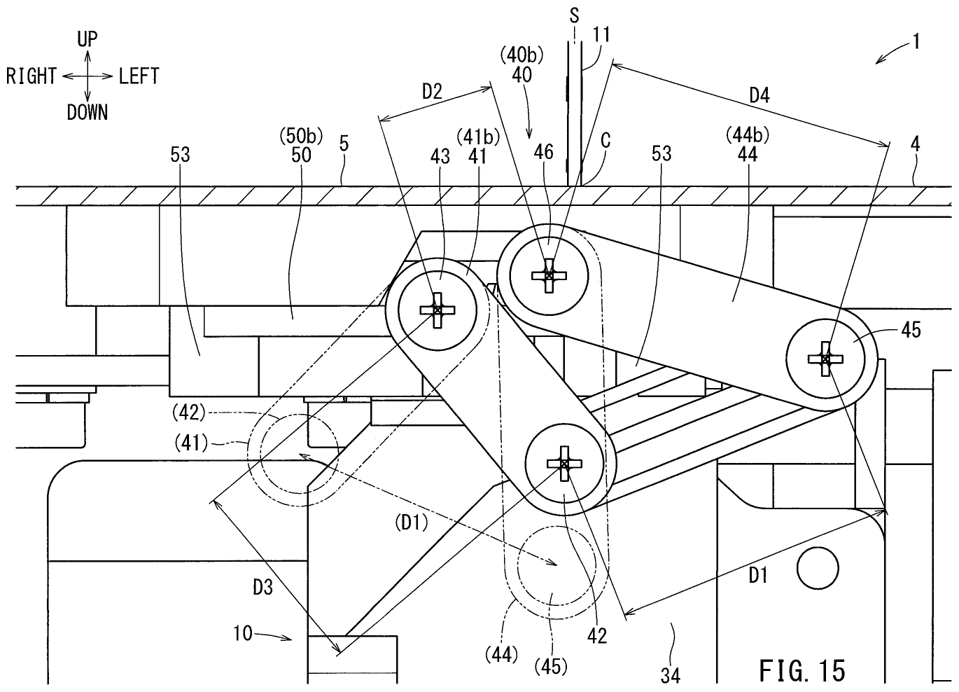

A first example of this disclosure will be described with reference to FIGS. 1 to 17. As shown in FIG. 1, a table saw 1 has a base 2 placed on a floor or the like and a table 4 supported horizontally by the base 2. A workpiece is placed on the table 4. A main body 10 is supported below the table 4. A substantially disk-shaped cutting blade 11, which is referred to as a tipped saw blade, is rotatably supported on the main body 10. The cutting blade 11 is supported by the main body 10 in an extended position in a front-back direction. A user is positioned in front of the table saw 1 as shown in the figure to perform the cutting operation. In the following description, a front side where the user is positioned is defined as a front side, and a rear side is defined as a rear side from the user's viewpoint. Up-down and left-right directions are defined based on the user's position.

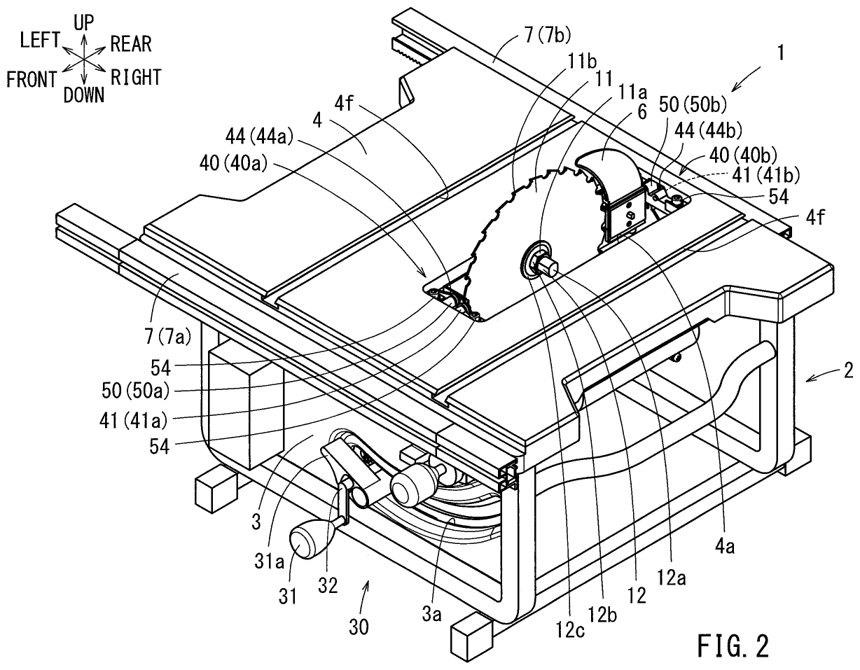

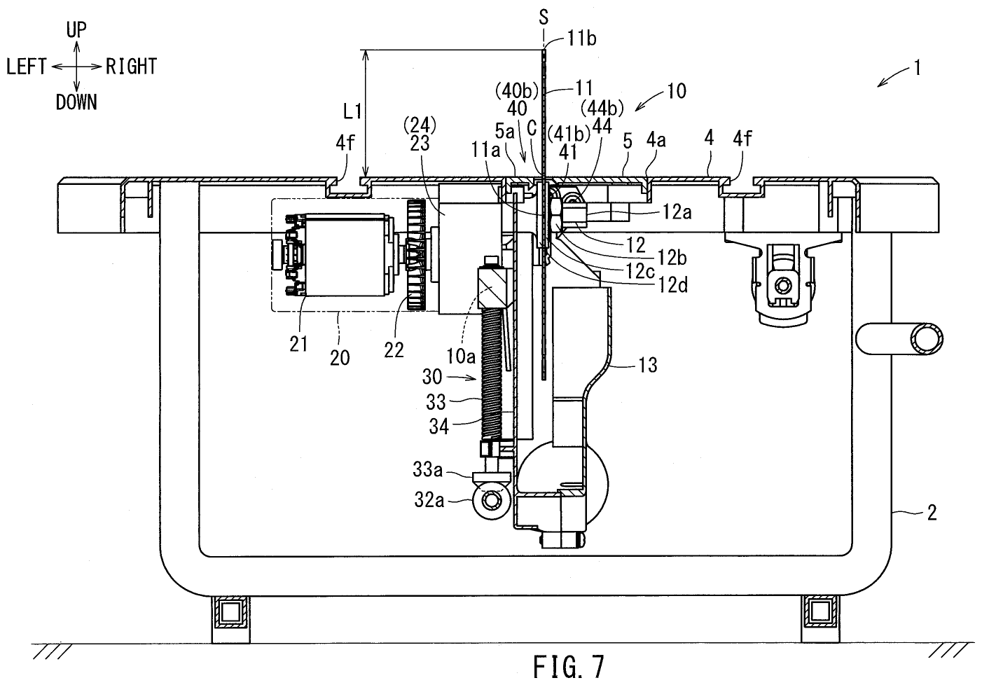

As shown in FIGS. 1 and 2, a top surface of the table 4 is formed with a substantially rectangular through-hole 4a, which is elongated in the front-rear direction. A blade edge plate 5 is attached to the through hole 4a. In the center of the blade edge plate 5, a slot-shaped through-hole 5a is formed that extends in linearly in the front-back direction. The upper region of the cutting blade 11 is inserted into the through hole 5a from below and protrudes above the top surface of the table 4. The lower region of the cutting blade 11 is covered so as not to be exposed by the blade case 13 (see FIG. 7), which is integrally formed with the main body 10. The table 4 is formed with a rail recess 4f extending in the front-back direction at the left and right of the blade edge plate 5. A miter gauge (not shown) can be mounted in the rail recess 4f. A fence surface of the miter gauge is tilted at a predetermined angle to a workpiece feeding direction, and the miter gauge is slidably moved in an extending direction of the rail recess 4f (workpiece feeding direction) with the fence surface in contact with the workpiece. This allows the workpiece to be cut at a predetermined angle to the contact surface.

As shown in FIGS. 1 and 2, each rail 7 for a guide ruler (rip fence) extending in a left-right direction is provided at a front of a front end and behind a rear end of the table 4. Each guide ruler (not shown) may be attached to each of the rail 7a or 7b. Each fence surface of the guide ruler is parallel to the workpiece feeding direction. A distance between the cutting blade 11 and the fence surface of the guide ruler in the left-right direction is adjusted to have a required distance. The workpiece may be cut to have a required left-right width by cutting the workpiece while sliding the workpiece along the fence surface.

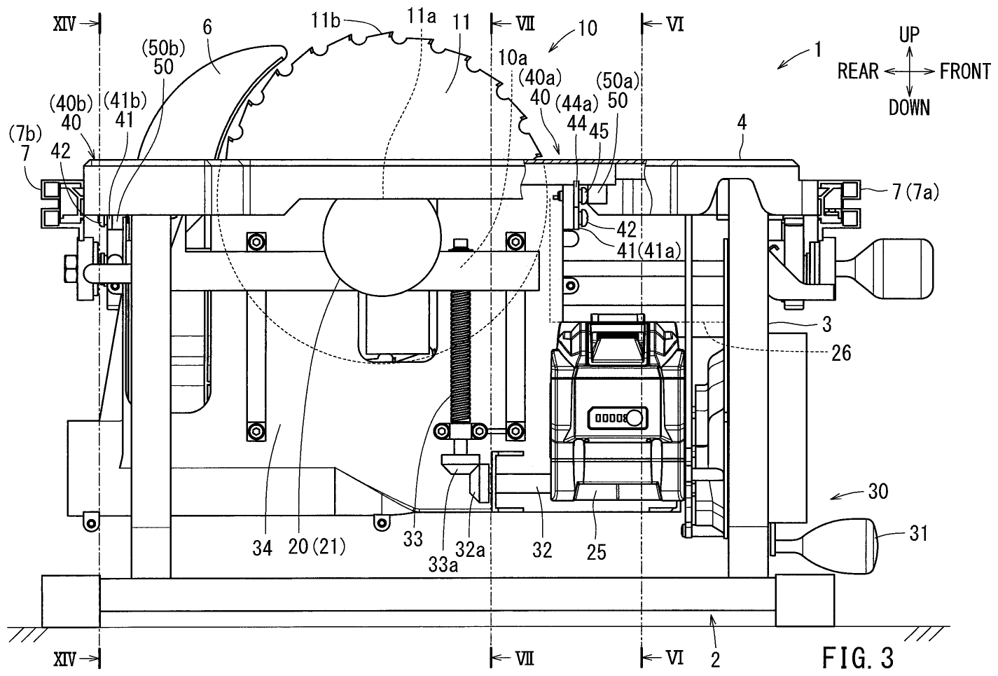

As shown in FIGS. 3 and 7, the main body 10 has a motor 21, a motor housing 20 configured to accommodate the motor 21, and an output shaft 12 that rotates around an axis of rotation as the motor 21 is driven. A cutting blade 11 is integrally rotatably mounted on the output shaft 12 extending in the left-right direction. The cutting blade 11 rotates around the central axis of rotation of the output shaft 12. Hereinafter, an intersection of the central axis lines of the cutting blade 11 and the output shaft 12 is referred to as the center 11a of the cutting blade 11. A tip 12a of the output shaft 12 protrudes to the right relative to the cutting blade 11. A male thread is formed on an outer circumference of the right part of the output shaft 12. The cutting blade 11 is interposed between an outer flange 12c and an inner flange 12d in the left-right direction, and the nut 12b is tightened onto the male thread of the output shaft 12. The cutting blade 11 is thus attached to the output shaft 12. Instead of the tipped cutting saw blade 11, a groove-cutting blade having a plurality of substantially disk-shaped cutting blades aligned in the axial direction of the output shaft 12, for example, referred to as a stacked dado set, may be mounted on the output shaft 12. The output shaft 12 is provided with a length extending in a left-right direction to allow the stacked cutter to be mounted.

As shown in FIGS. 1 and 3, the workpiece placed on the table 4 is fed from front to back toward the cutting blade 11, which protrudes above the top surface of the table 4 and integrally rotates with the output shaft 12. As a result, a cutting edge of a front area of the cutting blade 11 cuts into the workpiece. At a rear of a rear region of the cutting blade 11, an arc-shaped riving knife 6 is provided along the cutting edge of the cutting blade 11.

As shown in FIGS. 3 and 7, the motor housing 20 is disposed to the left of cutting blade 11. The motor housing 20 and a motor shaft of the motor 21 extend parallel to the output shaft 12. A fan 22 is integrally attached to the motor shaft of the motor 21 for introducing cooling air into the motor 21 and other parts. The fan 22 is disposed to the right of the motor 21 in the motor housing 20. A gear housing 23 is provided between the motor housing 20 and the cutting blade 11. The gear housing 23 houses a reduction gear train 24 configured to reduce the rotational speed of the motor 21 and transmits it to the output shaft 12.

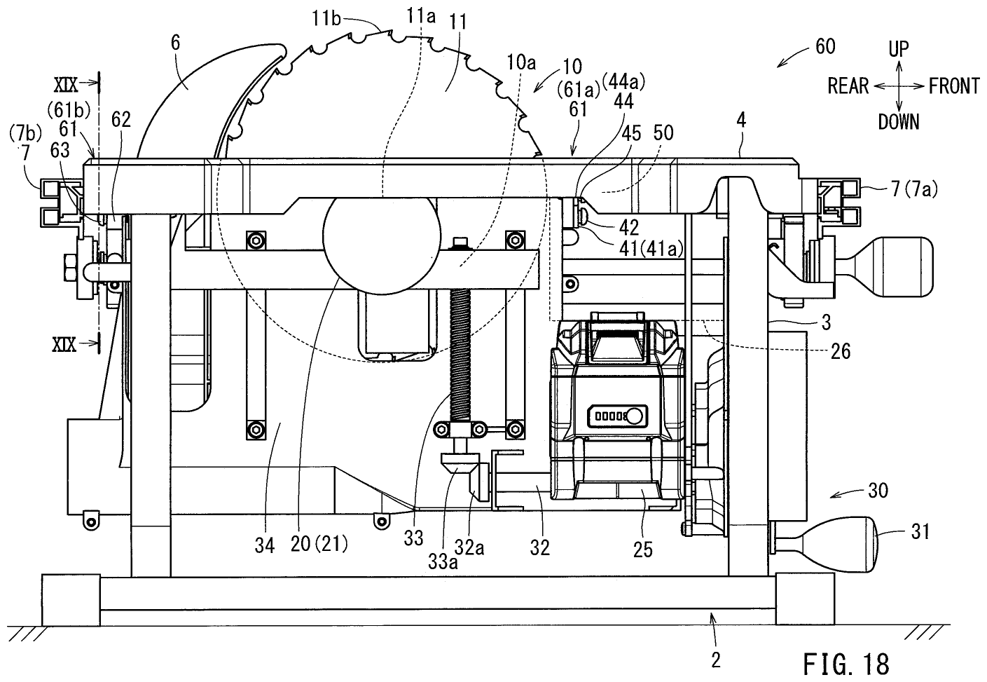

As shown in FIG. 3, a base 2 is provided with a battery mounting section 26 where a rectangular box-shaped battery 25 can be removably mounted. The battery 25 is primarily used as a power source for the motor 21. The battery 25 can be mounted to the battery mounting section 26 while being moved from left to right with respect to the underside of the battery mounting section 26. The battery 25 can be removed from the battery mounting section 26 by sliding it in the direction opposite to the mounting direction. The battery 25 is, for example, a lithium-ion battery with an output voltage of 36V. The battery 25 can be removed from the battery mounting section 26 and repeatedly recharged using a separately prepared charger. The battery 25 can be used as a power source with other rechargeable power tools such as screw drivers and electric drills. The battery 25 is not shown in the drawings except for FIGS. 3 and 18.

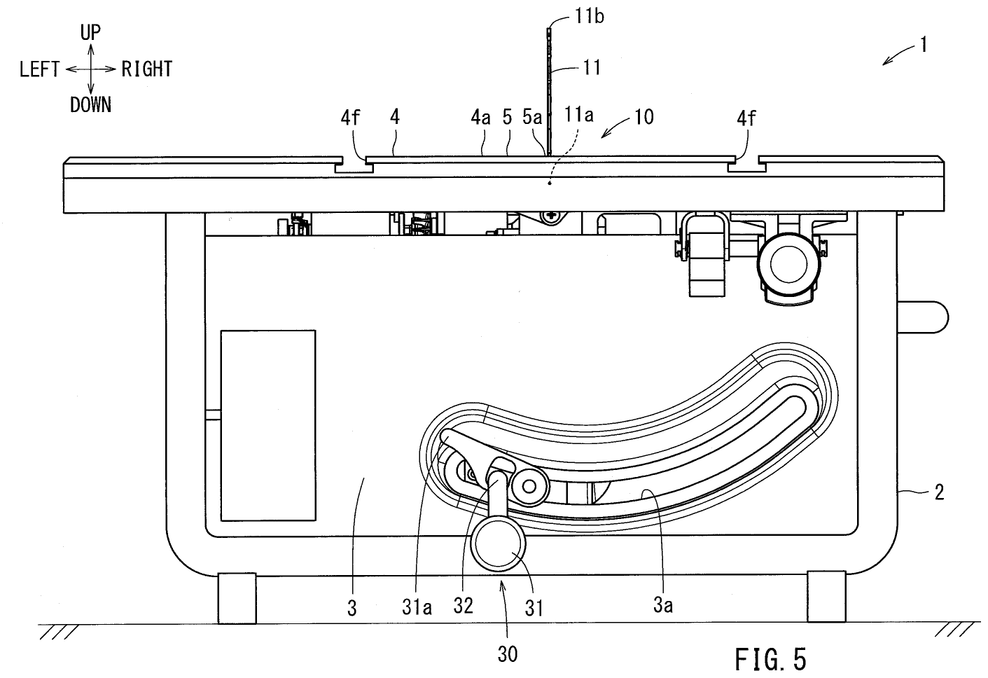

As shown in FIGS. 1 and 5, the front of the base 2 is provided with a planar base front side 3 extending in the up-down direction and left-right direction. The base front side 3 is provided with an arc-shaped hole 3a that penetrates in the front-back direction. The arc-shaped hole 3a extends in an arc-shape around a left-right inclination center of a lift support portion 34 described below. A rotation shaft 32 of the lifting shaft 30 described below is inserted into the arc-shaped hole 3a.

As shown in FIGS. 3, 4, 7, and 8, the table saw 1 has a lift mechanism 30 that can change the vertical position of the cutting blade 11 relative to the table 4. The main body 10 has a lift support portion 34 that moves upward and downward by the guide mechanism 40 described below but not by the lift mechanism 30. The cutting blade 11, the output shaft 12, the motor housing 20, the gear housing 23, move in an up-down direction with respect to the lift support portion 34 by the lift mechanism 30. The lifting mechanism 30 has a lifting handle 31 that can be rotated and operated by the user and a rotation shaft 32 that is integrally formed with the lifting handle 31. The lifting handle 31 is provided in front of the base front side 3. The rotation shaft 32 extends forward and backward over the center of rotation of the lifting handle 31. The rotation shaft 32 is inserted into the arc-shaped hole 3a in the base front side 3. The lifting handle 31 and the rotation shaft 32 are supported by the lift support portion 34 so as to be rotatable around the axis. A drive side bevel gear 32a is provided at a rear end of the rotation shaft 32.

As shown in FIGS. 3, 4, 7, and 8, the lifting mechanism 30 has a lifting shaft 33 that consists of a ball screw. The lifting shaft 33 is rotatably supported to the lift support portion 34 in the position extending in the up-down direction. The lifting shaft 33 is disposed between the cutting blade 11 and the motor 21 as viewed from the front-back direction. The lifting shaft 33 is disposed between the front end of the cutting blade 11 and the center 11a of the cutting blade 11 as viewed in the left-right direction. A driven-side bevel gear 33a is provided at a lower end of the lifting shaft 33. The driven-side bevel gear 33a engages a drive-side bevel gear 32a on the rotation shaft 32. When the rotation shaft 32 rotates around an axis extending in the front-back direction, the lifting shaft 33 rotates around an axis extending in the up-down direction. The lifting shaft 33 is screwed to the female thread 10a of the main body 10. By rotating the lifting shaft 33 around the axis of rotation, the main body 10 including the female screw 10a moves in the up-down direction by screw feeding. The cutting blade 11 moves in the up-down direction along with the main body 10. This allows the length of blade protrusion (cutting depth), in which the upper end 11b of the cutting blade 11 protrudes from the table 4 in a direction parallel to the cutting blade 11, to be changed.

As shown in FIGS. 2, 3, and 6, the table saw 1 has a guide mechanism 40 that can change an inclination angle of the main body 10 with respect to a plane perpendicular to the table 4 and the length of blade protrusion. The main body 10, including the lift support portion 34, is supported by the base 2 so as to be inclined in a left-right direction. The user can grasp the lifting handle 31 to incline the main body 10 to the left or right. When moving the lifting handle 31 to the left or right, the rotation shaft 32 moves left or right along the extending direction of the arc-shaped hole 3a. The lifting handle 31 is provided with a lock lever 31a that releasably locks the left-right movement of the lifting handle 31. The lifting handle 31 can move left and right to incline the main body 10 when the lock lever 31a is unlocked. The guide mechanism 40 guides the main body 10 to incline left-right and to move in the up-down direction parallel to the cutting blade 11.

As shown in FIGS. 2 and 3, the guide mechanism 40 includes a front guide mechanism 40a, which is provided in front of the cutting blade 11, and a rear guide mechanism 40b, which is provided behind the cutting blade 11. Between the front guide mechanism 40a and the rear guide mechanism 40b in the front-back direction, for example, the cutting blade 11, the output shaft 12, the motor 21, and the lifting shaft 33 may be arranged. The rear guide mechanism 40b also corresponds to a guide member configured to guide the left-right inclination of the main body 10 in the present disclosure.

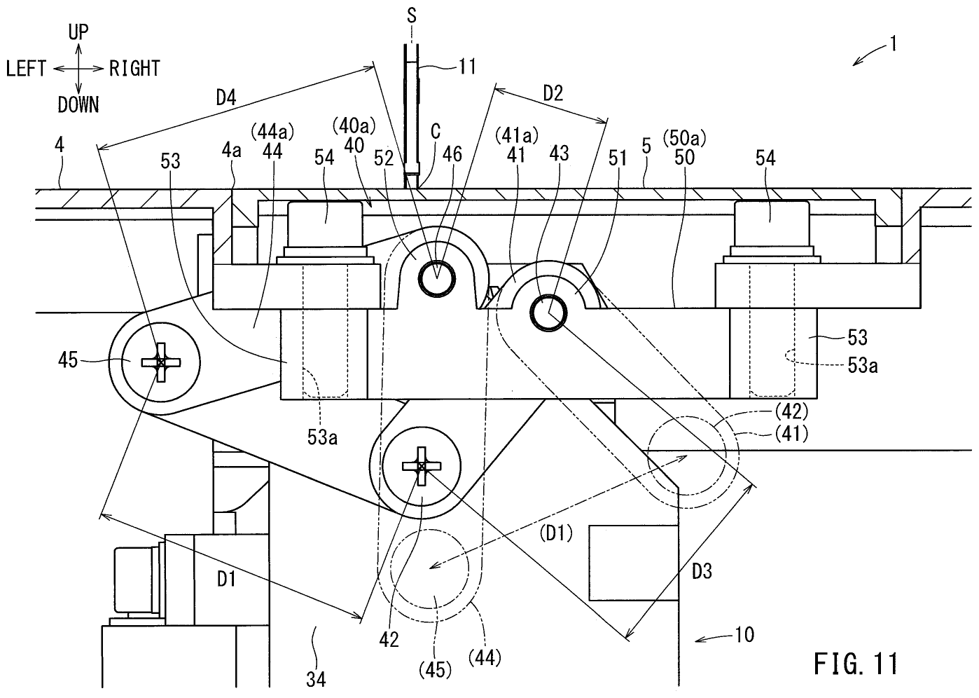

As shown in FIGS. 11 to 13 and 15, the guide mechanism 40 is provided with two linearly extending links such as a first link 41 and a second link 44. The second link 44 is provided on the side on which the cutting blade 11 tilts with respect to the first link 41, i.e., to the left. The second link 44 is longer than the first link 41. The front guide mechanism 40a has a first front link 41a as the first link 41 and a second front link 44a as the second link 44. The rear guide mechanism 40b has a first rear link 41b as the first link 41 and a second rear link 44b as the second link 44. The front guide mechanism 40a as being viewed from the front is provided with a structure that is symmetrical with the rear guide mechanism 40b as viewed from the rear. In other words, the front guide mechanism 40a and the rear guide mechanism 40b are provided with the same structure in the left-right direction. In the following explanation, only the front guide mechanism 40a will be described in detail, but the rear guide mechanism 40b is also provided with the same structure.

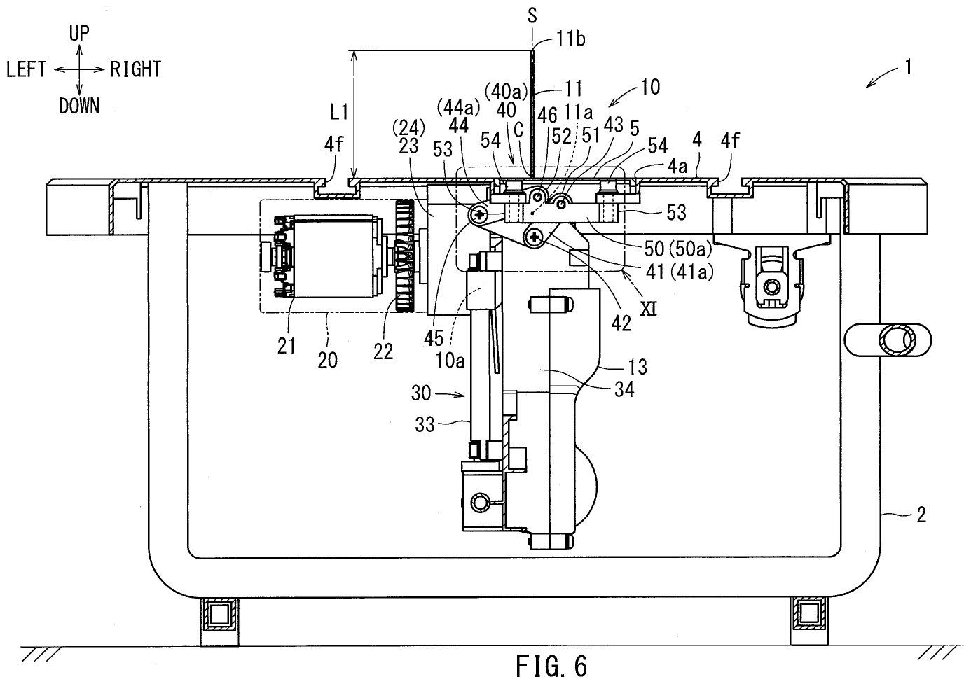

As shown in FIGS. 6 and 11 to 13, the first link 41 is connected to the main body 10 by a first body-side shaft 42 extending in the front-back direction. The first link 41 is rotatable around the axis of rotation of the first body-side shaft 42. The second link 44 is connected to the main body 10 by a second body-side shaft 45 extending in the front-back direction. The second link 44 is rotatable around the axis of rotation of the second body-side shaft 45. A link support 50 configured to support the first link 41 and the second link 44 is attached to the table 4. The structure of attaching the link support 50 to the table 4 will be described in detail later. The first link 41 is connected to the main body 10 by a first table-side shaft 43 extending in the front-back direction. The first link 41 is rotatable around the axis of rotation of the first table-side shaft 43. The second link 44 is connected to the main body 10 by the second table-side shaft 46 extending in the front-back direction. The second link 44 is rotatable around the axis of rotation of the second table-side shaft 46.

As shown in FIGS. 6 and 11 to 13, the front guide mechanism 40a and rear guide mechanism 40b are disposed in the left-right direction and the second table-side shaft 46 is located to the right of an intersection area C where the cutting blade 11 and an extension surface of the table 4 intersect. The first table-side shaft 43 is positioned to the right and below the second table-side shaft 46. The first body-side shaft 42 is located substantially directly below the second table-side shaft 46 when the tilt angle of the cutting blade 11 with respect to a plane S perpendicular to the table 4 is 0°. The first body-side shaft 42 is located to the right and below the first table-side shaft 43 when the tilt angle of the cutting blade 11 with respect to the plane S is 45°. The first body-side shaft 42 is located farther away from the intersection area C than the first table-side shaft 43 when the tilt angle of the cutting blade 11 with respect to the plane S is between 0° and 45°. The intersection area C between the cutting blade 11 and the extension surface of the table 4 is an area having a width at least as wide as the thickness of the cutting blade 11.

As shown in FIGS. 6 and 11, the second body-side shaft 45 is located to the left and below the second table-side shaft 46 and to the left and above the first body-side shaft 42 when the tilt angle of the cutting blade 11 with respect to the plane S is 0°. The second body-side shaft 45 is located substantially directly below the second table-side shaft 46 when the tilt angle of the cutting blade 11 with respect to the plane S is 45°. The second body-side shaft 45 is located farther away from the intersection area C than the second table-side shaft 46 when the tilt angle of the cutting blade 11 with respect to the plane S is between 0° and 45°.

As shown in FIGS. 6 and 11 to 13, the second body-side shaft 45 is located between the cutting blade 11 and the right end of the motor 21 in a direction perpendicular to the cutting blade 11, regardless of the tilt angle of the cutting blade 11 with respect to the plane S. Therefore, regardless of the tilt angle of the cutting blade 11 with respect to the plane S, at least a part of the second link 44 is located between the cutting blade 11 and the motor 21 when viewed from the front or the rear. The second main body-side shaft 45 is located on an approximate extension of the lifting shaft 33 when viewing from the front or rear, regardless of the tilt angle of the cutting blade 11 with respect to the plane S. Therefore, regardless of the tilt angle of the cutting blade 11 with respect to the plane S, at least a part of the second link 44 is located between the cutting blade 11 and the lifting shaft 33 when viewing from the front or rear.

As shown in FIG. 11, a first distance D1, which is the distance between the first body-side shaft 42 and the second body-side shaft 45, is longer than a second distance D2, which is the distance between the first table-side shaft 43 and the second table-side shaft 46. The state in which the first distance D1 is longer than the second distance D2 is maintained at any tilt angle of the cutting blade 11 with respect to the plane S between 0° and 45°. A third distance D3, which is the distance between the first body-side shaft 42 and the first table-side shaft 43, is shorter than a fourth distance D4, which is the distance between the second body-side shaft 45 and the second table-side shaft 46.

In the right-angle position shown in FIGS. 6 and 7, the tilt angle of the cutting blade 11 with respect to the plane S perpendicular to the table 4 is 0°. At this time, the workpiece can be cut in a so-called right-angle cut. The output shaft 12 extends parallel to the table 4 below the table 4 or the blade edge plate 5. Therefore, the output shaft 12 does not interfere with the table 4 or blade edge plate 5. The length of blade protrusion L1 is the distance from the upper end 11b of the cutting blade 11 to the table 4 in the direction parallel to the cutting blade 11. In the right-angle position, it is possible to cut workpiece with a thickness of a length close to the radius of the cutting blade 11.

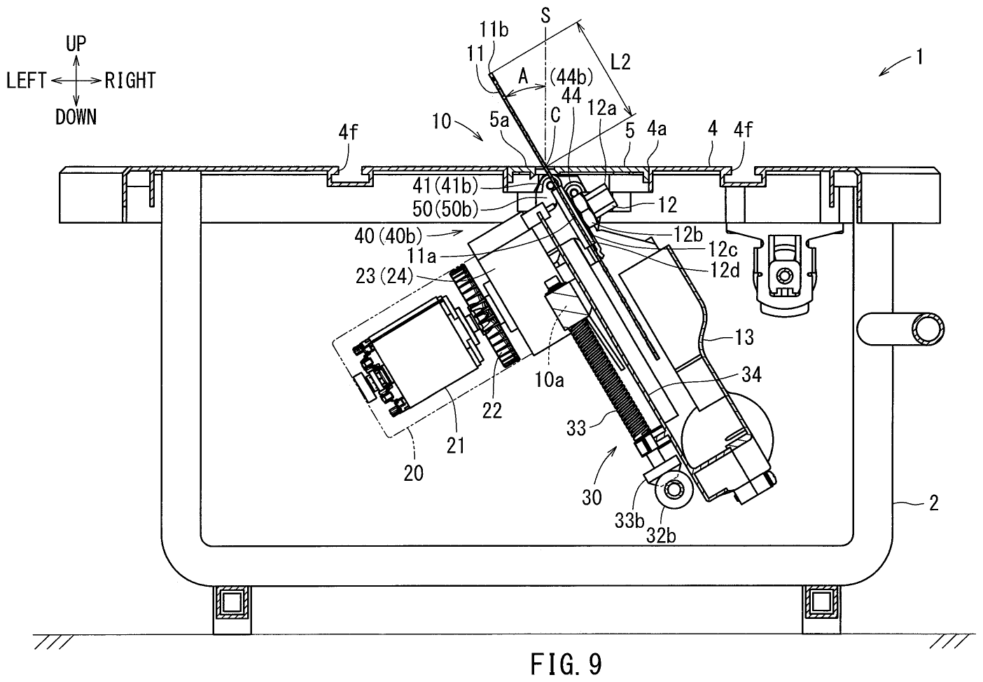

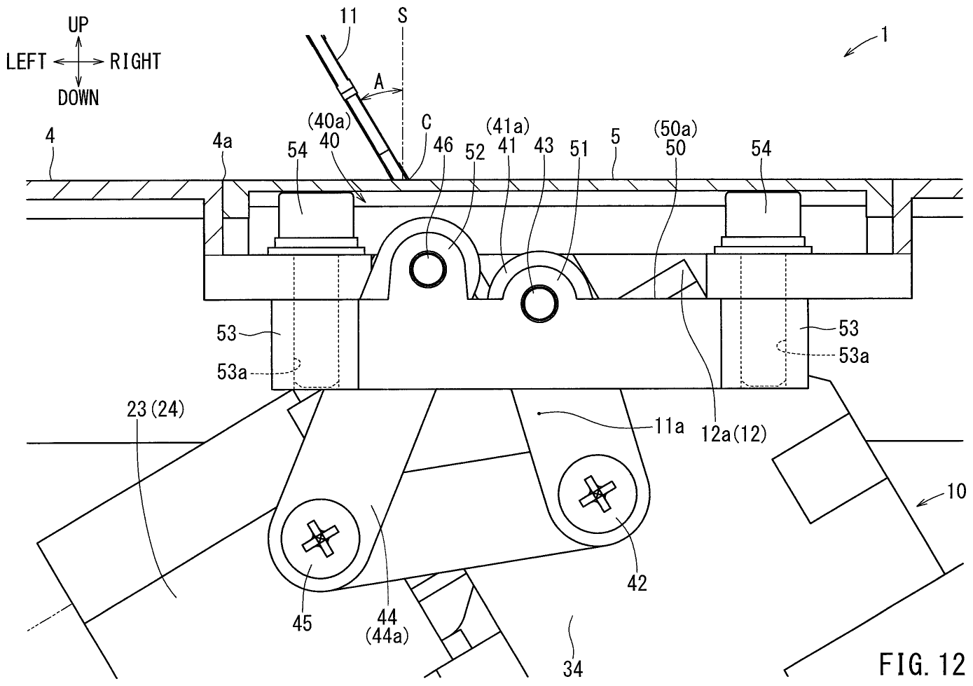

As shown in FIGS. 9 and 12, the main body 10 is tilted to a left tilted position. At this time, the tilt angle A of the cutting blade 11 with respect to the plane S is 30°. At this time, the workpiece can be cut in a so-called bevel cut. The cutting blade 11 maintains the state of being intersected with the extension surface of the table 4 in the same intersection area C as in the right-angled position. The upper end 11b of the cutting blade 11 is closer to the table 4 to the extent that the cutting blade 11 is tilted. The first body-side shaft 42 and the second body-side shaft 45 are further away from the intersection area C than in the right-angle position. Moreover, since the second link 44 is longer than the first link 41, the left part of the main body 10 is farther away from the intersection area C than the right part of the main body 10. This causes the main body 10, including the cutting blade 11, to move further to the right and downward than in the right-angle position. The center 11a of the cutting blade 11 shifts downward and away from the table 4 more than when in the right-angle cut.

As shown in FIG. 9, the output shaft 12 extends in a direction inclined at 300 to the table 4. A tip 12a at the right end of the output shaft 12 is located below the undersides of the table 4 or the blade edge plate 5. Therefore, the output shaft 12 does not interfere with the table 4 or the blade edge plate 5. The length of blade protrusion L2 is the distance from the upper end 11b of the cutting blade 11 to the table 4 in the direction parallel to the cutting blade 11. The length of blade protrusion L2 is less than the length of blade protrusion L1 (see FIG. 6).

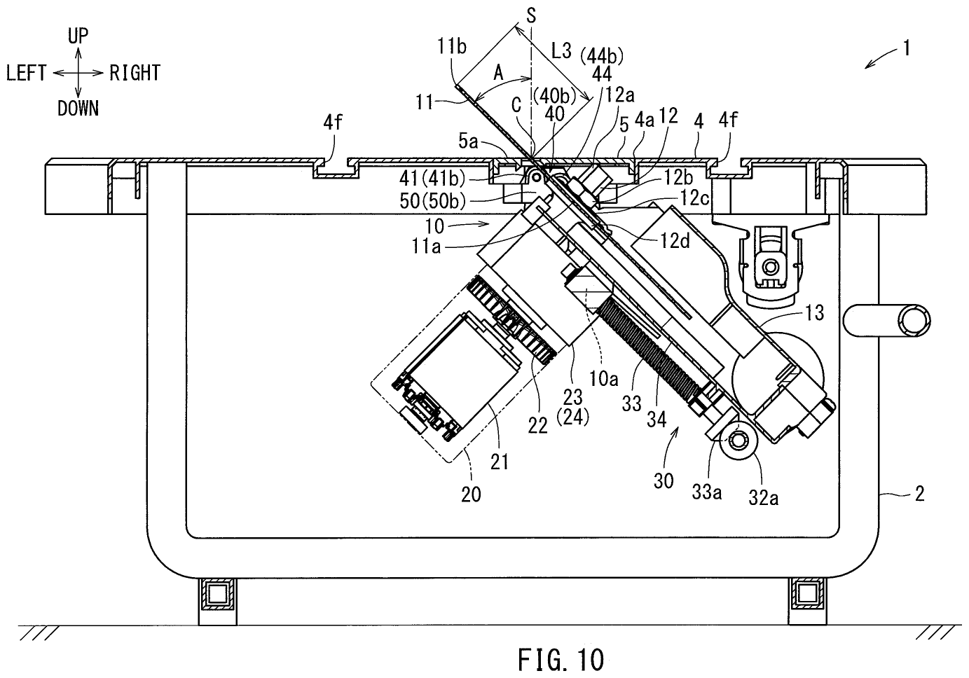

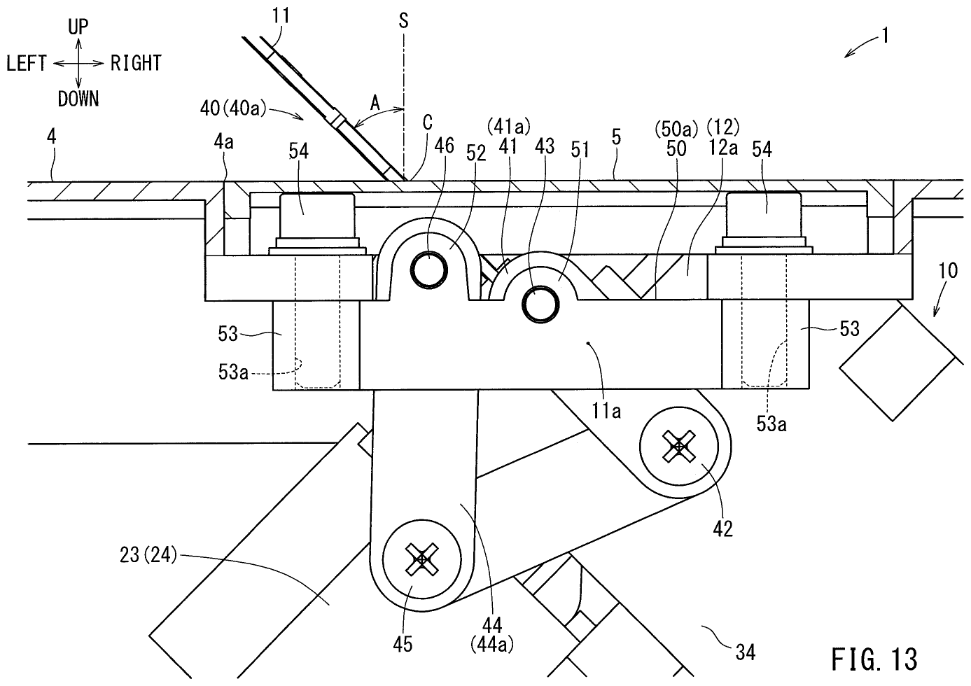

As shown in FIGS. 10 and 13, the main body 10 is tilted further to the left, and the tilt angle A of the cutting blade 11 with respect to the plane S is 45°. The workpiece can be cut in a so-called bevel cut. The cutting blade 11 maintains the state of being intersected with the extension surface of the table 4 in the same intersection area C as in the right-angle position. The upper end 11b of the cutting blade 11 is closer to the table 4 to the extent that the cutting blade 11 is tilted. The first body-side shaft 42 and the second body-side shaft 45 are further apart from the intersection area C than in the right-angle position and in the tilted position of the cutting blade 11 at the tilt angle of 30°. Moreover, since the second link 44 is longer than the first link 41, the left part of the main body 10 is further away from the intersection area C than the right part of the main body 10. This causes the main body 10, including the cutting blade 11, to move further to the right and downward. The center 11a of the cutting blade 11 moves downward and away from the table 4 further than when in the right-angle position and when the tilt angle of the cutting blade 11 is 30°.

As shown in FIG. 10, the output shaft 12 extends in a direction inclined at 450 to table 4. The tip 12a at the right end of the output shaft 12 is located below the undersides of the table 4 or the blade edge plate 5. Therefore, the output shaft 12 does not interfere with the table 4 or the blade edge plate 5. The length of blade protrusion L3 is the distance from the upper end 11b of the cutting blade 11 to the table 4 in the direction parallel to the cutting blade 11. The length of blade protrusion L3 is even shorter than the length of blade protrusion L2 (see FIG. 9).

As shown in FIGS. 6 and 11 to 13, the main body 10 including the cutting blade 11 moves to the right and downward by the guide mechanism 40 as it tilts to the left. Moreover, the tilt angle of the cutting blade 11 can be continuously changed, and the left/right and front/back positions of the main body 10 including the cutting blade 11 can be continuously changed. Therefore, the workpiece can be cut at an angle other than the tilt angle of the cutting blade 11 shown in the drawings such as, for example, when the tilt angle of the cutting blade 11 is 5°, 10°, 20°, 40°, etc.

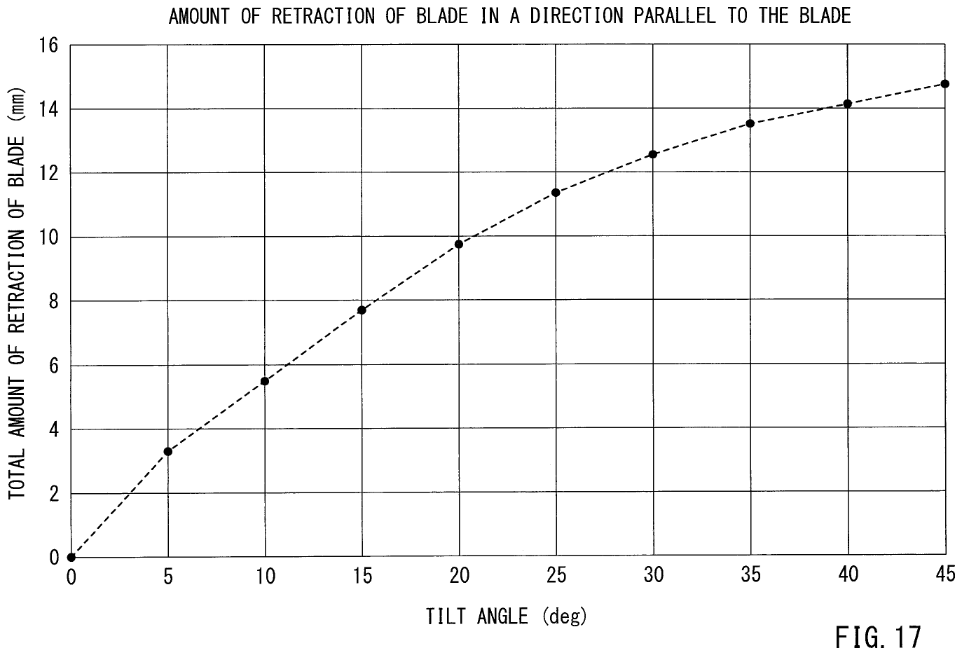

The relationship between the tilt angle of the cutting blade 11 with respect to a plane S perpendicular to the table 4 and the amount of retraction of the cutting blade 11 in a direction parallel to the cutting blade 11 will be described with reference to FIGS. 7, 9, 10, and 17. The amount of retraction of the cutting blade 11 is 0 mm when the tilt angle of the cutting blade 11 with respect to the plane S is 0°. As the tilt angle increases, the total amount of retraction of the cutting blade 11 increases. As the tilt angle increases, the incremental amount of retraction of the cutting blade 11 decreases. In other words, the smaller the tilt angle, the greater the amount of retraction of the cutting blade 11 per tilt angle. The smaller the tilt angle, the less the amount of retraction of the cutting blade 11 per tilt angle. For example, the amount of retraction of the cutting blade 11 in a range at a tilt angle of 0° to 5° may be 3.28 mm. For example, the amount of retraction of the cutting blade 11 in a range at a tilt angle of 15° to 20° may be about 2.08 mm. For example, the amount of retraction of the cutting blade 11 in a range at a tilt angle of 30° to 35° may be about 0.97 mm. Therefore, the graph shown in FIG. 17 depicts a so-called upward convex curve.

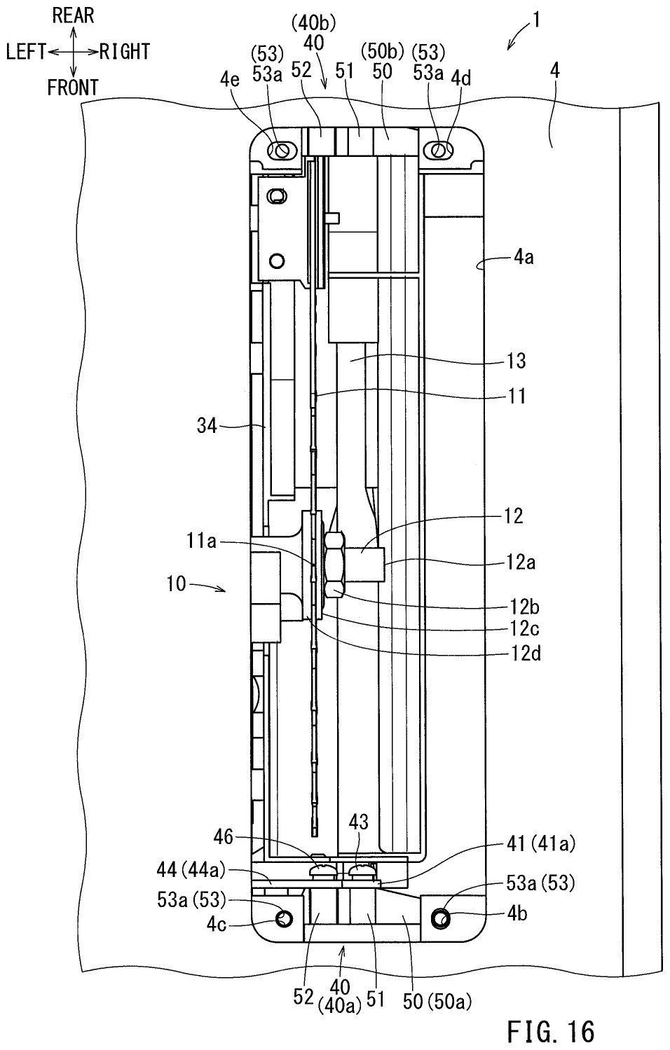

As shown in FIGS. 2 and 16, the link support 50 includes a front link support 50a that is attached below the front of the through hole 4a in the table 4 and a rear link support 50b that is attached below the rear of the through hole 4a. The link support 50 may be attached integrally to the table 4 by having the screws 54 fastened from above with the blade edge plate 5 removed. At both left and right ends of the link support 50, a pair of substantially cylindrical bosses 53 is provided with screw holes 53a extending in the front-back direction (see FIG. 11). A substantially cylindrical boss 51 to which a screw is fastened as the first table-side shaft 43 and a substantially cylindrical boss 52 to which a screw is fastened as the second table-side shaft 46 are provided between the pair of bosses 53.

As shown in FIG. 16, on the right side of the front end of the through hole 4a of the table 4, an elongated hole 4b is formed that penetrates in the up-down direction to allow insertion of a screw 54 (see FIG. 11) that is fastened to the screw hole 53a on the right side of the front link support 50a. The elongated hole 4b is formed to have an elongated circular shape that is slightly longer in the front-back direction than the screw hole 53a. On the left side of the front end of the through hole 4a of the table 4, a circular hole 4c is provided that penetrates in an up-down direction to allow insertion of a screw 54 that is fastened to the screw hole 53a on the left side of the front link support 50a. The circular hole 4c is provided in a circular shape having substantially the same diameter as the screw hole 53a. The elongated holes 4b are provided to have a substantially elongated circular shape, which allows the position (angle) of the front link support 50a in the rotational direction around the circular holes 4c to be finely adjusted and attached to the table 4.

As shown in FIG. 16, on the right side of the rear end of the through hole 4a of the table 4, an elongated hole 4d is provided that passes through in the up-down direction to allow insertion of a screw 54 (see FIG. 2) that is fastened to the screw hole 53a on the right side of the rear link support 50b. The elongated hole 4d is provided to have an elongated circular shape longer in the left-right direction than the screw hole 53a. On the left side of the rear end of the through hole 4a of the table 4, an elongated hole 4e is provided that penetrates in an up-down direction to allow insertion of a screw 54 that is fastened in the screw hole 53a on the left side of the rear link support 50b. The elongated hole 4d is provided to have an elongated circular form longer in the left-right direction than the screw hole 53a. The elongated holes 4d and 4e are provided in the form of an elongated circle, which allows the left and right positions of the rear link support 50b to be finely adjusted and attached to the table 4. Therefore, the blade edge plate 5 is removed and the four screws 54 on the front, rear, left and right sides are loosened to finely adjust the angle of the front link support 50a and the left-right direction of the rear link support 50b (resulting in the cutting blade 11 rotating around the circular hole 4c). This allows the cutting blade 11 to be adjusted so that it is parallel to the rail recess 4f.

As described above, the table saw 1 has a table 4 on which the workpiece is placed as shown in FIGS. 6, 11 to 13. The table saw 1 has a main body 10 arranged below the table 4 and equipped with a motor 21. The table saw 1 has a cutting blade 11 connected to the motor 21 and penetrating the table 4 in an up-down direction. The table saw 1 has a guide mechanism 40 that serves to tilt the cutting blade 11 along with the main body 10 with respect to the table 4. The guide mechanism 40 moves the center 11a of the cutting blade 11 downward as the upper end 11b of the cutting blade 11 moves closer to the table 4, away from the table 4 and to the right (second side) opposite to the left (first side) where the upper end 11b moves.

Therefore, as the tilt angle of the cutting blade 11 with respect to the plane S perpendicular to the table 4 increases, the upper end 11b of the cutting blade 11 approaches the table 4. As the upper end 11b of the cutting blade 11 approaches the table 4, the cutting blade 11 moves to the right opposite to the tilting direction. As a result, the length from the upper end 11b of the cutting blade 11 to the table 4 in a direction parallel to the cutting blade 11, i.e., a length of blade protrusion, reduces. Thus, as the tilt angle of the cutting blade 11 with respect to the plane S perpendicular to the table 4 increases, the length of blade protrusion can be automatically reduced. This prevents the output shaft 12 configured to rotatably support the cutting blade 11 from interfering with the underside of the table 4 etc. during bevel cutting.

Moreover, this configuration allows the cutting blade 11 to be shifted to the right while tilting the upper end 11b of the cutting blade 11 to the left. This configuration allows the cutting blade 11 to tilt without moving the intersection area C (virtual tilt axis) where the cutting blade 11 and the extension surface of table 4 intersect. Therefore, for example, the distance between the intersection area C and the guide ruler positioned on the table 4 can be kept constant; therefore, the workpiece is cut at a constant width with the workpiece placed against the guide ruler, both in the case of a right-angle cut or a bevel cut.

As shown in FIGS. 6 and 11 to 13, the guide mechanism 40 has a first link 41 configured to connect the table 4 to the main body 10. The guide mechanism 40 has a second link 44 that is positioned to the left (first side) relative to the first link 41 and connects the table 4 and the main body 10. Therefore, by using two links, the first link 41 and the second link 44, the cutting blade 11 can be tilted in a different trajectory than the rotation around the intersection area C where the cutting blade 11 and the extension surface of the table 4 intersect. Therefore, when tilting the cutting blade 11, the cutting blade 11 can be automatically moved so that the length of blade protrusion is restricted.

As shown in FIG. 11, the table saw 1 has a first body-side shaft 42 configured to rotatably connect the first link 41 to the main body 10. The table saw 1 has a first table-side shaft 43 that rotatably connects the first link 41 to the table 4. The table saw 1 has a second body-side shaft 45 that rotatably connects the second link 44 to the main body 10. The table saw 1 has a second table-side shaft 46 that connects the second link 44 to the table 4. The first body-side shaft 42 is positioned farther from the intersection area C of the cutting blade 11 and the table 4 than the first table-side shaft 43. The second body-side shaft 45 is located farther from the intersection area C than the second table-side shaft 46.

Therefore, when the first link 41 rotates around the first table-side shaft 43, the travel distance of the first body-side shaft 42 with respect to the intersection area C increases. When the second link 44 rotates around the second table-side shaft 46, the travel distance of the second body-side shaft 45 with respect to the intersection area C increases. This allows for a larger and more precise movement of the cutting blade 11 in a direction parallel to the cutting blade 11. This allows the cutting blade 11 to move precisely and smoothly so that the length of blade protrusion reduces as the tilt angle increases.

As shown in FIG. 11, the table saw 1 has a first body-side shaft 42 that rotatably connects the first link 41 to the main body 10. The table saw 1 has a first table-side shaft 43 that rotatably connects the first link 41 to the table 4. The table saw 1 has a second body-side shaft 45 that rotatably connects the second link 44 to the main body 10. The table saw 1 has a second table-side shaft 46 that rotatably connects the second link 44 to the table 4. The first distance D1 between the first body-side shaft 42 and the second body-side shaft 45 is longer than the second distance D2 between the first table-side shaft 43 and the second table-side shaft 46.

Therefore, the first link 41 rotates around the first table-side shaft 43 and the second link 44 rotates around the second table-side shaft 46. At this time, because the first distance D1 is greater than the second distance D1, the first body-side shaft 42 and the second body-side shaft 45 more easily move so as to mutually rotate than to move mutually parallel. This prevents the main body 10 including the cutting blade 11 from moving parallel to each other in the left-right direction. This allows the cutting blade 11 and the extension surface of the table 4 to remain intersected in the intersection area C.

As shown in FIG. 11, the second link 44 is longer than the first link 41. Therefore, when the cutting blade 11 is tilted to the left, the second body-side shaft 45 moves away from the intersection area C. This movement allows the upper end 11b of the cutting blade 11 to approach the intersection area C as the cutting blade 11 is tilted to the left. As a result, the length of blade protrusion may be decreased as the tilt angle of the cutting blade 11 increases.

As shown in FIG. 6, at least a part of the first link 41 or the second link 44 is disposed between the cutting blade 11 and the motor 21 when viewed from a direction perpendicular to the tilting direction of the cutting blade 11. Therefore, at least a part of the first link 41 or the second link 44 is disposed between the heavy motor 21 and the cutting blade 11. Therefore, the stability of the position of the main body 10, which is supported by the guide mechanism 40 in a tiltable and movable manner, can be enhanced.

As shown in FIG. 6, the table saw 1 has a lifting shaft 33 that is supported by the table 4 and guides the main body 10 in a direction parallel to the cutting blade 11. At least a part of the first link 41 or the second link 44 is disposed between the cutting blade 11 and the lifting shaft 33 as viewed from a direction perpendicular to the tilting direction of the cutting blade 11. Therefore, the lifting shaft 33 and the guide mechanism 40 may be moved to approach in a direction perpendicular to the tilting direction of the cutting blade 11. Therefore, when an external force acts on the cutting blade 11, the rigidity of the main body 10 can be maintained. Thus, even when the length of blade protrusion is changed by the lifting shaft 33, the tilting and movement of the cutting blade 11 by the guide mechanism 40 can be made to follow the same path.

As shown in FIG. 3, the guide mechanism 40 has a rear guide mechanism (a guide member) 40b that is supported by the table 4 and guides the main body 10 in the direction to be moved by the first front link 41a and the second front 44a link. The motor 21 is disposed between the first front link 41a and the rear guide mechanism 40b in the front-back direction along which the cutting blade 11 extends. The first front link 41a and the rear guide mechanism 40b can be provided with the heavy motor 21 interposed therebetween. Therefore, the stability of the posture of the main body 10 supported by the guide mechanism 40 may be enhanced not only in the tilting direction but also in the front-back direction.

As shown in FIG. 3, the table saw 1 has a lifting shaft 33 that is supported by the table 4 and guides the main body 10 in a vertical direction. The guide mechanism 40 has a rear guide mechanism (guide member) 40b that is supported by the table 4 and guides the main body 10 in the direction to move the main body 10 by the first front link 41a and second front link 44a. The lifting shaft 33 is disposed between the first front link 41a and the rear guide mechanism 40b in the front-back direction along which the cutting blade 11 extends. The first front link 41a and the rear guide mechanism 40b can be provided with the lifting shaft 33 disposed therebetween. Thus, the structure to support the main body 10 vertically movably in a direction parallel to the cutting blade 11 can be supported not only by the lifting shaft 33 but also by the front and rear guide mechanisms 40. This may increase the stability of the tilting trajectory that tilts the main body 10 to the left or right.

As shown in FIG. 16, the table saw 1 has a link support 50 that is releasably fixed to the table 4 and connected to the first link 41 and the second link 44. The link support 50 is formed with elongated holes 4b, 4d, 4e penetrating in the up-down direction through which screws 54 (see FIG. 2) can be fitted, and the screws 54 fitted in the elongated holes 4b, 4d, 4e can be tightened to the table 4 from above. Therefore, the screws 54 can be loosened or tightened from above the table 4. The parallelism between the cutting blade 11 and the rail recess 4f can therefore be easily adjusted by moving the link support 50.

As shown in FIG. 17, the length of blade protrusion in the direction parallel to the cutting blade 11 decreases as the tilt angle of the cutting blade 11 with respect to the plane S perpendicular to the table 4 increases (see FIG. 6, 11 to 13). The length of protrusion decreases more as the tilt angle decreases, and the length of decrease reduces less as the tilt angle increases. When the tilt angle of the cutting blade 11 with respect to the plane S perpendicular to the table 4 is near 0°, the length of blade protrusion decreases significantly. When the cutting blade 11 is in a right-angle position with a tilt angle of 0°, the length of blade protrusion can be sufficiently increased. When the cutting blade 11 is inclined even slightly, the output shaft 12 supporting the cutting blade 11 can be quickly retracted downward to avoid interference with the table 4 or other objects. Further, the output shaft 12 can be sufficiently retracted downward from the table 4 when the tilt angle of the cutting blade 11 is small. Therefore, the decrease in the length of blade protrusion when the tilt angle of the cutting blade 11 is large can be reduced. This allows the necessary height of the blade protrusion to be secured even when the tilt angle of the cutting blade 11 is large.

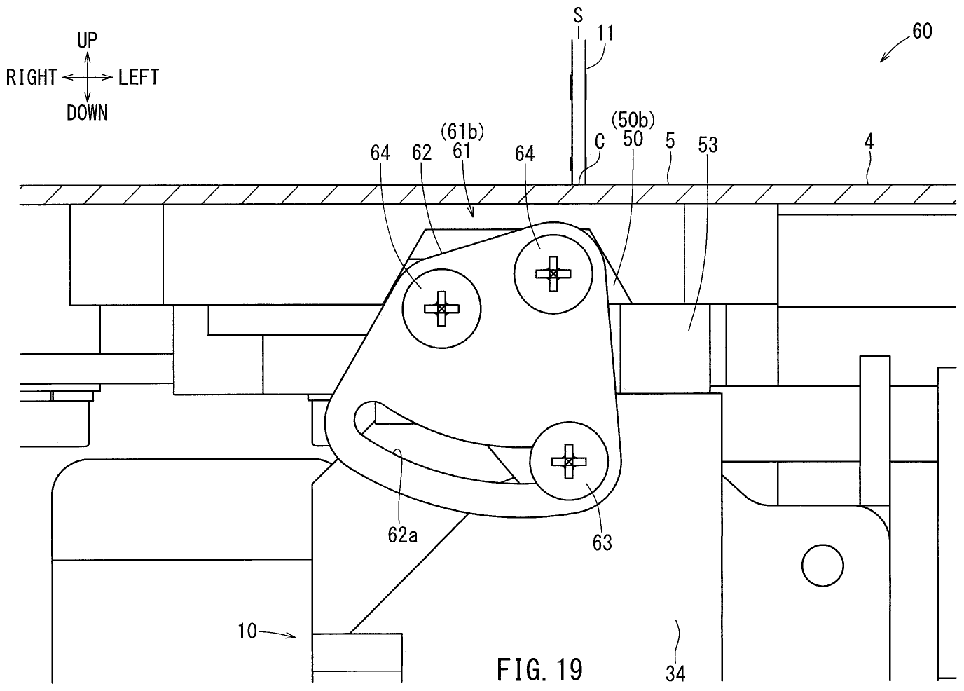

Hereinafter, a second example of the present disclosure will be described with reference to FIGS. 18 to 19. A table saw 60 of the second example has a guide mechanism 61 instead of the guide mechanism 40 of the table saw 1 shown in FIG. 3. The guide mechanism 61 includes a front guide mechanism 61a provided in front of the cutting blade 11 and a rear guide mechanism 61b provided behind the cutting blade 11. The cutting blade 11, the output shaft 12, the motor 21, the lifting shaft 33, etc. are located between the front guide mechanism 61a and the rear guide mechanism 61b in the front-back direction. The front guide mechanism 61a has a first link 41 and a second link 44 similarly to the first example. The rear guide mechanism 61b does not have a link mechanism, but instead has a guide member 62 that guides the tilting of the main body 10. In the following description, only the parts that differ from the first example will be described in detail.

As shown in FIGS. 18 and 19, the guide member 62 is a plate-shaped member with the front-back direction as the thickness direction. The guide member 62 is provided in a substantially fan shape when viewed from the rear. The upper part of the guide member 62 is attached to a rear link support 50b via screws 64. The guide member 62 is provided with an arc-shaped hole 62a that passes through the guide member 62 in the front-back direction and extends in an arc-shaped hole in the left-right direction. As illustrated by FIG. 19, a shaft member 63 attached to the main body 10 is inserted through the arc-shaped hole 62a. When the cutting blade 11 is tilted, the shaft member 63 moves along the extending direction of the arc-shaped hole 62a. Therefore, when the main body 10 including the cutting blade 11 is tilted and moved by the front guide mechanism 61a, the tilting and moving of the main body 10 can be guided by the guide member 62 at the rear of the main body 10. By not providing a link in the rear guide mechanism 61b, the structure can be made simple.

Still in FIGS. 18-19, the guide mechanism 62 has a guide member 62 that is supported by the table 4 and guides the main body 10 in the direction to be moved by the first front link 41a and the second front link 44a. The motor 21 is disposed between the first front link 41a and the guide member 62 in the front-back direction along which the cutting blade 11 extends. Therefore, the first front link 41a and the guide member 62 may be provided with the heavy motor 21 interposed therebetween. Therefore, the stability of the posture of the main body 10 supported by the guide mechanism 61 may be enhanced not only in the tilting direction but also in the front-back direction.

As shown in FIG. 18, the table saw 60 has the lifting shaft 33 that is supported by the table 4 and guides the main body 10 in a vertical direction. The guide mechanism 61 has a guide member 62 that is supported by the table 4 and guides the main body 10 in the direction to move the main body 10 by the first front link 41a and the second front link 44a. The lifting shaft 33 is disposed between the first front link 41a and the guide member 62 in the front-back direction along which the cutting blade 11 extends. Therefore, the first front link 41a and the guide member 62 can be provided with the lifting shaft 33 disposed therebetween. Thus, the structure to support the main body 10 upwardly and downwardly movably in a direction parallel to the cutting blade 11 can be supported not only by the lifting shaft 33 but also by the front and rear guide mechanisms 61. Therefore, the stability of the posture of the main body 10 can be improved.

Various modifications may be made to the table saw 1 and 60 according to the present example described above. Instead of the tipped cutting saw blade 11, a stacked dado set with a large axial thickness may be mounted on the output shaft 12. The length of the output shaft 12 extending to the right is longer to allow mounting of the stacked dado set. However, as shown in the present example, as the main body 10 including the cutting blade 11 is tilted to the left or right, it is moved downward on the opposite side of the tilting direction. This sufficiently prevents interference between the output shaft 12 and the table 4 even when the output shaft 12 is inclined with respect to the table 4.

The table saw 1, 60 is illustrated where the upper end 11b of the cutting blade 11 tilts to the left. Alternatively, the upper end 11b of the cutting blade 11 may tilt to the right. Although the tilt angle of the cutting blade 11 with respect to a plane S perpendicular to the table 4 was set to 0° to 45°, the range of the tiltable angle may be changed as needed. For example, the cutting blade 11 may be tilted at a tilt angle of 450 or more. For example, when determining the tilt angle at which the upper end 11b of the cutting blade 11 tilts to the left as positive, the cutting blade may be tilted from a negative to a positive tilt angle.

A lifting shaft 33 consisting of a ball screw was descried as an example. Instead, the lifting shaft 33 may be a pole on which the main body 10 can slide, for example. A table saw 1 that uses a rechargeable battery 25 as a power source to drive the motor 21 was described as an example. Alternatively, an AC power source, such as a commercial 100 V AC power source, for example, may be used as the power source.

The example shows that a guide mechanism 61 in which the guide member 62 is provided behind the cutting blade 11 and the first link 41 and the second link 44 are provided only in front of the cutting blade. Alternatively, the guide member 62 may be provided in front of the cutting blade 11, and the first link 41 and the second link 44 may be provided only behind the cutting blade.

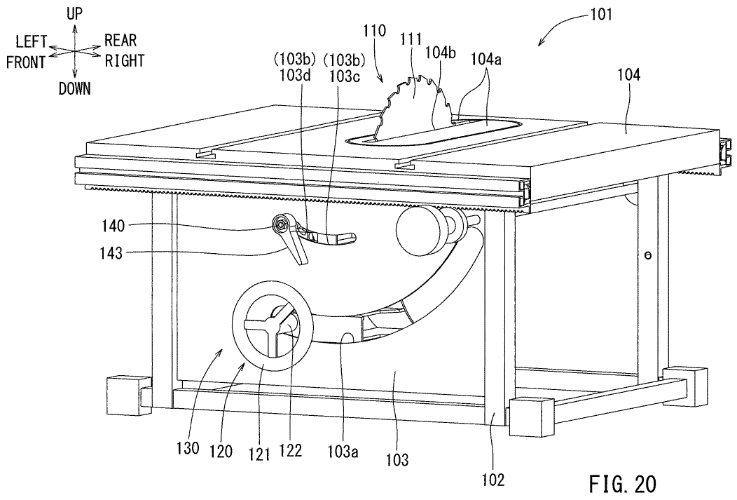

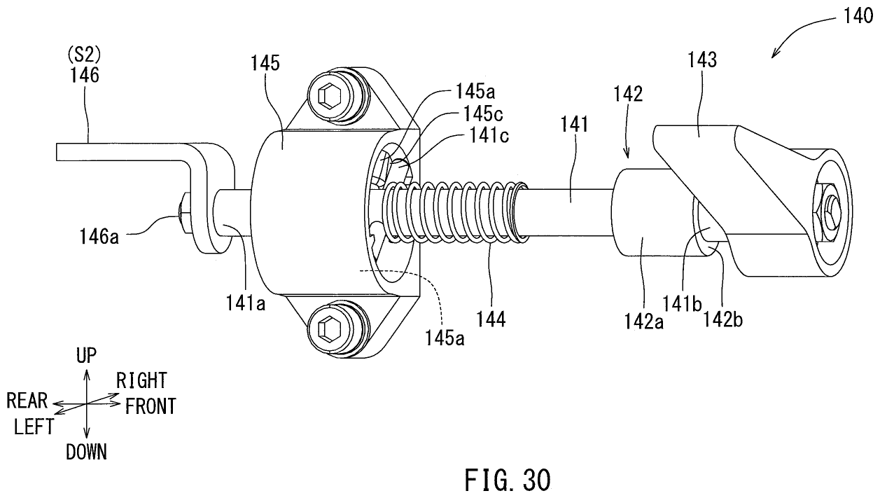

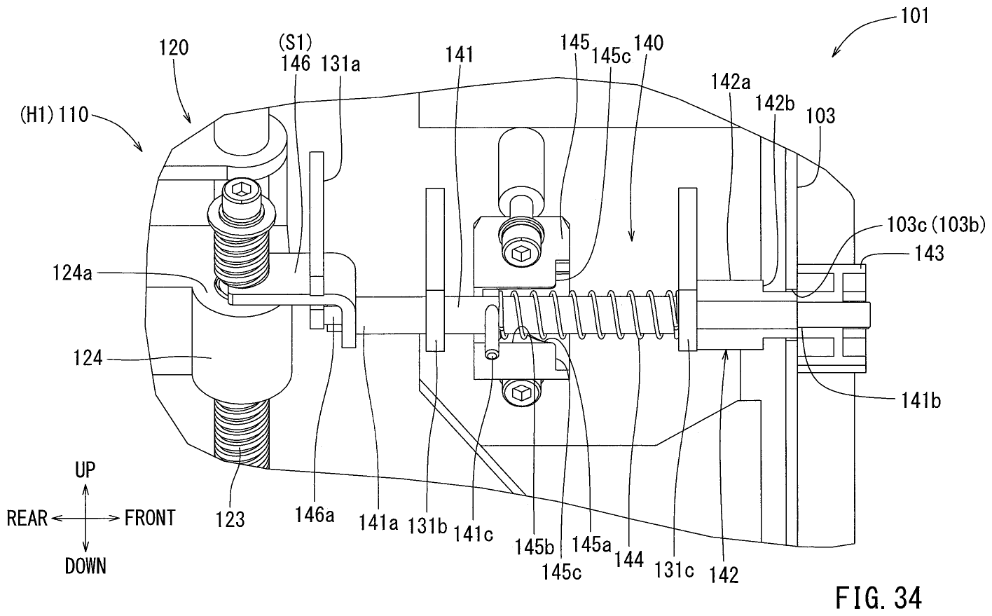

Other examples of the present disclosure will be described with reference FIGS. 20-35.

In the right-angle cut position (hereinafter, referred to as “right-angle position”), the output shaft extends horizontally. Therefore, the output shaft can be moved to the vicinity of the underside of the table to increase the cutting depth. On the other hand, in the bevel cut position (hereinafter referred to as “bevel position”), the output shaft is inclined to the left of right with respect to the table. Therefore, it is necessary to restrict the cutting depth so that the output shaft does not interfere with the underside of the table. In particular, if a cutting blade having a thick left-right width for groove cutting can be mounted on the output shaft, the output shaft needs to be extended longer. Therefore, it is necessary to reduce the cutting depth so that the output shaft and the underside of the table do not interfere with each other in the bevel position. The device for adjusting cutting depth usually consists of a single device for both right-angle and bevel positions. Therefore, with conventional table saws, it was difficult to increase the cutting depth even in the right-angle position.

Therefore, in a table saw where the main body can be inclined to the table, it is necessary to be able to adjust the cutting depth of the cutting blade according to the inclination angle of the main body while avoiding interference between the main body and the table.

A table saw according to one aspect of the present disclosure has a table on which a workpiece is placed. The table saw has a main body that is arranged below the table and rotates a cutting blade that penetrates the table. The table saw has a movable mechanism to allow the cutting blade to move along with the main body with respect to the table. The movable mechanism can adjust a height of the main body with respect to the table and an angle of the main body with respect to the table. The movable mechanism includes a height adjustment mechanism that moves the main body between a reference height and a limit-exceeding height higher than the reference height to change a length of blade protrusion upward from the table. The table saw has an angle adjustment mechanism to change the inclination angle of the main body with respect to a plane perpendicular to the table. The table saw includes a height restriction mechanism that restricts the height adjustment mechanism to control an upward movement amount of the main body from the reference height to the restricted height lower than the limit-exceeding height when the inclination angle of the main body is in a non-predetermined state in which the inclination angle of the main body is not at the predetermined angle or within the predetermined angle range.

Thus when the main body is in a predetermined state (not a non-predetermined state), in which the inclination angle of the main body is at the predetermined angle or within the predetermined angle range, the main body is allowed to move upward to the limit-exceeding height. When the main body is in the predetermined state, for example, the output shaft that rotatably supports the cutting blade is substantially parallel to the table. Therefore, the cutting depth of the cutting blade may be deepened while the main body and the table do not interfere. When the main body is in a non-predetermined state in which the inclination angle of the main body is not at the predetermined angle or within the predetermined angle range, the main body is maintained at the restricted height such that the upward movement is restricted. When the main body is in the non-predetermined state, the output shaft of the cutting blade, which rotatably supports the cutting blade, may be inclined with respect to the table. Therefore, by restricting the upward movement of the main body, interference of the inclined main body with the table can be restricted. Thus, the cutting depth of the cutting blade can be deepened only when the inclination angle of the main body is in the predetermined state, while the interference between the main body and the table is restricted regardless of the inclination angle of the main body.

According to another aspect of the present disclosure, the table saw includes an inclination restriction mechanism that restricts the inclination angle of the main body to less than or equal to the predetermined angle or within the predetermined angle range when the height restriction mechanism is released to allow the main body to move beyond the restricted height to the limit-exceeding height. Therefore, when the main body is moved to the limit-exceeding height, the main body is restricted to incline to the inclination angle of the non-predetermined state. Thus, the cutting depth can be deepened only when the inclination angle of the main body is in the predetermined state. Moreover, the main body at the limit-exceeding height may be prevented from interfering with the table.

According to another aspect of the present disclosure, the table saw has a restriction maintaining mechanism that always activates the height restriction mechanism when the main body is in a non-predetermined state. Thus, the main body can be restricted from moving upward above the restricted height. This prevents the main body, which is inclined in the non-predetermined state, from interfering with the table.

According to another aspect of the present disclosure, the height restriction mechanism has a stopper shaft equipped with a lift stopper at its tip. By moving the stopper shaft in its axial direction, the lift stopper moves between a restricted position located above a stopper contact portion of the height adjustment mechanism and a release position away from the stopper contact portion. Therefore, the simply structured stopper shaft and lift stopper allows the height restriction mechanism to operate reliably.

According to another aspect of the present disclosure, the table saw has a base front side formed with an elongated hole through which the stopper shaft is inserted. The elongated hole has an arc-shaped guide hole and an enlarged hole that communicates the guide hole and has a larger diameter than the guide hole. The stopper shaft has a main body that enters the guide hole and is guided along the guide hole, and an intermediate portion that is attached to the main body and has a diameter that is larger than the guide hole and can be inserted into the enlarged hole. The intermediate portion enters the enlarged hole and restricts the inclination angle of the main body to a predetermined angle or within a predetermined angle range. Thus, the simply structured elongated hole formed in the base front side and the simply structured intermediate portion provided in the stopper shaft allows the inclination restriction mechanism to operate reliably.

According to another aspect of the present disclosure, when the inclination angle of the main body is in a non-predetermined state, the intermediate portion contacts the base front side and is restricted from entering the guide hole, thereby maintaining the operation of the height restriction mechanism. Therefore, simply structured guide hole formed in the base front side and the intermediate portion provided in the stopper shaft allows the height restriction mechanism to operate reliably and to maintain its operation.

According to another aspect of the present disclosure, the table saw has a power conversion mechanism that converts a portion of rotational force of the stopper shaft around its axis into a force of axial movement of the stopper shaft. Therefore, a simple operation to rotate the stopper shaft around its axis allows the stopper shaft to move in its axial direction and activate the height restriction mechanism.

According to another aspect of the present disclosure the power conversion mechanism has a lead surface that extends spirally around the axis of the stopper shaft. Therefore, the force of rotation around the axis of the stopper shaft can be efficiently converted into the axial movement force while preventing wear of the stopper shaft. This improves the operability of moving the stopper shaft in the axial direction.

According to another aspect of the present disclosure, the power conversion mechanism includes a surface that communicates the lead surface and extends in a direction different from the lead surface and has a position-retaining portion that restricts the axial movement of the stopper shaft. Therefore, the stopper shaft and lift stopper can be prevented from moving in the axial direction unintentionally. Furthermore, the lead surface and the position-retaining portion are communicated with each other, thereby allowing the stopper shaft to easily switch between a state in which the stopper shaft can move in the axial direction and a state in which the movement of the stopper shaft is restricted.

According to another aspect of the present disclosure, the table saw has a biasing member that biases the stopper shaft in the axial direction. Therefore, by constantly biasing the stopper shaft and the lift stopper in the axial direction, the lift stopper, which restricts the upward movement of the main body, can be prevented from being unintentionally released due to vibration or other reasons.

According to another aspect of the present disclosure, the stopper shaft has a shaft front that penetrates forward beyond the base front side. An operation portion for rotating the stopper shaft around its axis is provided on the shaft front. Thus, the operation portion is provided in a position where the user can easily operate, thereby improving the operability of the operation portion.

According to another aspect of the present disclosure, the operation portion is a lever that integrally rotates with the stopper shaft around the axis of the stopper shaft. Therefore, an operation force to rotate the operation portion can be small using the principle of leverage. This can improve the operability of the operation portion.

According to another aspect of the present disclosure, the table saw has an output shaft that is provided on the main body and rotatably supports a disk-shaped cutting blade. The table saw has an inclination restriction mechanism that restricts the inclination angle of the main body to a predetermined state in which the inclination angle is at a predetermined angle or within a predetermined angle range. The output shaft can move further upward when the inclination restriction mechanism is released than when the inclination restriction mechanism is operated. Therefore, when the inclination angle of the main body is in the non-predetermined state, the output shaft can be prevented from interfering with the table. The cutting depth of the cutting blade can be deepened only when the inclination angle of the main body is in the predetermined state.

According to another aspect of the present disclosure, the height restriction mechanism has a stopper shaft that moves in an axial direction and releasably engages the height adjustment mechanism. The stopper shaft restricts the inclination angle of the main body when it moves in the axial direction and is disengagement from the height adjustment mechanism. Therefore, a single operation to move the stopper shaft in the axial direction can simultaneously disengage the height restriction mechanism and restrict the inclination angle of the main body.

Examples of the present disclosure will be described with reference to FIGS. 20 to 35. As shown in FIG. 20, a table saw 101 has a base 102 placed on a floor or the like and a table 104 supported horizontally by the base 102. A workpiece is placed on the table 104. A main body 110 is supported below the table 104. A user is positioned in front of the table saw 101 as shown in the figure to perform a cutting operation. In the following description, a front side where the user is positioned is defined as a front side, and a rear side is defined as a rear side from the user's viewpoint. Up-down and left-right directions are defined based on the user's position.

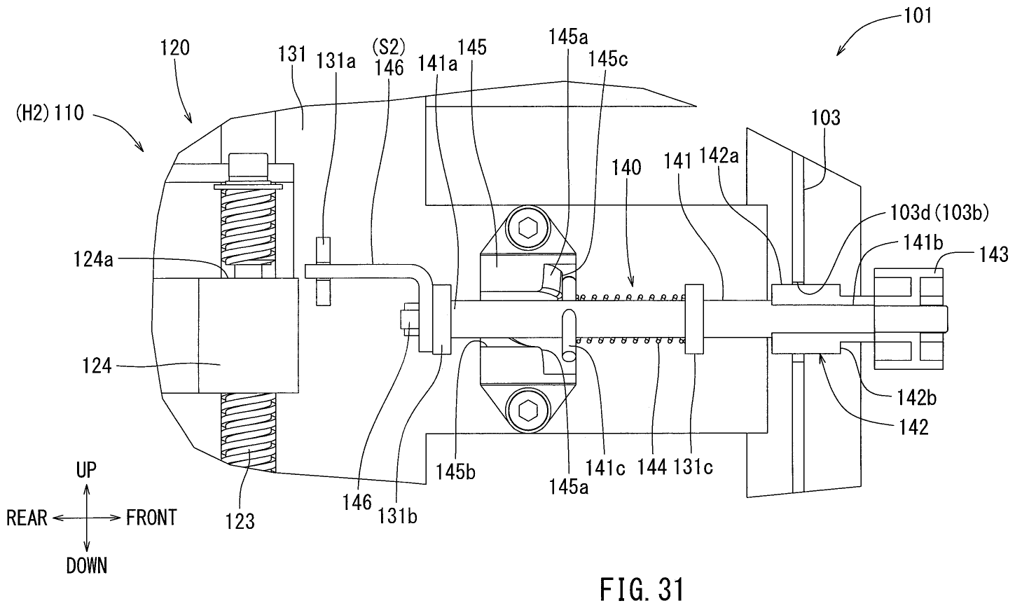

As shown in FIG. 31, a substantially disk-shaped cutting blade 111, which is referred to as a tipped saw blade, is rotatably supported on the main body 110. A blade edge plate 104a is provided on a top surface of the table 104. In the center of the blade edge plate 104a, a slot-shaped through hole 104b is formed that extends linearly in the front-back direction. An upper region of the cutting blade 111 is inserted through the through hole 104b and protrudes above the table 104. A lower region of the cutting blade 111 is covered so as not to be exposed by a blade case 13, which is integrally formed with the main body 110.

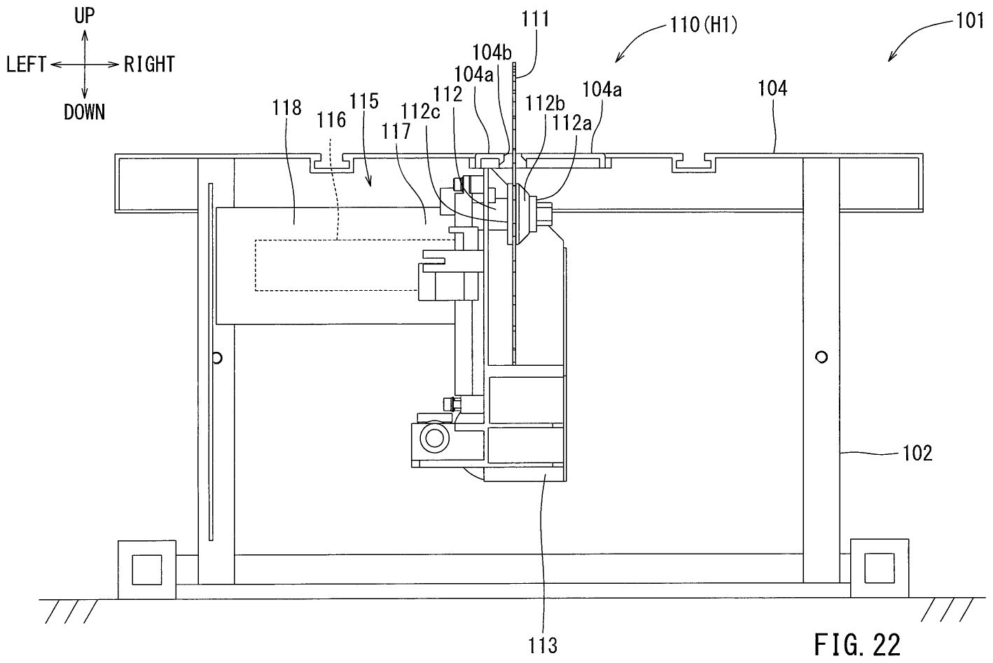

As shown in FIG. 22, the main body 110 has an electric motor 116, a motor housing 118 configured to accommodate the electric motor 116, and an output shaft 112 that rotates around an axis of rotation as the electric motor 116 is driven. The cutting blade 111 is integrally rotatably mounted on the output shaft 112 extending in the left-right direction. The cutting blade 111 is attached to the output shaft 112 by tightening a nut 112a to a male thread at a right end of the output shaft 112 while being interposed between an outer flange 112b and an inner flange 112c in the left-right direction. Instead of the tipped cutting saw blade 111, a groove-cutting blade consisting of a plurality of substantially disk-shaped cutting blades aligned in the axial direction of the output shaft 112, for example, referred to as stacked dado sets, may be mounted on the output shaft 112.

As shown in FIG. 22, a left portion of the output shaft 112 is inserted into a drive unit 115 provided in the main body 110. The drive unit 115 is provided with an electric motor 116 and a reduction gear train 117 that is provided in the motor housing 118. The rotation drive of the electric motor 116 is transmitted to the output shaft 112 via the reduction gear train 117. A workpiece placed on the table 104 is fed from the front to the rear toward the cutting blade 111, which protrudes above the table 104 and integrally rotates with the output shaft 112. This causes a front cutting edge of the cutting blade 111 to cut the workpiece by cutting into the workpiece. A so-called riving knife (not shown) is located along a rear side cutting edge of the cutting blade 111.

When the main body 110 is in a posture shown in FIG. 22, the output shaft 112 extends parallel to the table 104 and the cutting blade 111 extends perpendicularly to the table 104. In other words, a tilt angle of the cutting blade 111 with respect to a plane perpendicular to the table 104 is 0°. In this case, the workpiece can be cut in a so-called right-angle cut.

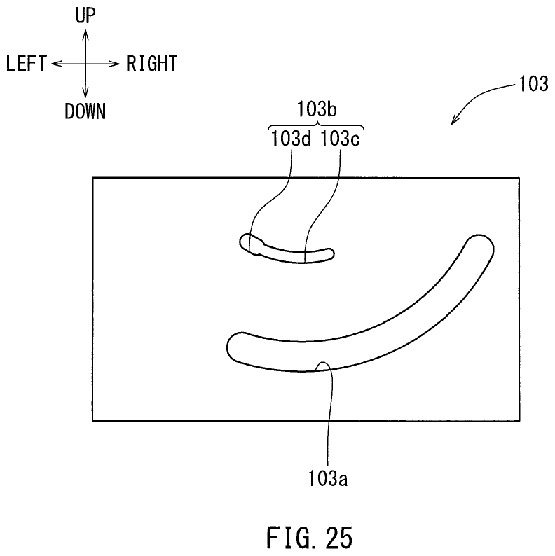

As shown in FIG. 20, a front of the base 102 is provided with a planar base front side 103 that extends in the up-down and left-right directions. The base front side 103 is formed with two elongated holes 103a and 103b passing through in the front-back direction. The elongated holes 103a and 103b extend in an arc-shape manner around a left-right inclination center of a main body support portion 131 by an angle adjustment mechanism 130 described below, respectively. The elongated hole 103b is formed on an upper side (inner circumference of the circular arc) of the elongated hole 103a. The elongated hole 103b has an arc-shaped guide hole 103c, which has a predetermined diameter, and an enlarged hole 103d, which communicates a left end of the guide hole 103c and has a larger diameter than the guide hole 103c (see FIG. 25). The enlarged hole 103d extends to form a slightly arc-shape along the extending direction of the elongated hole 103b.

As shown in FIG. 31, the table saw 101 has a height adjustment mechanism 120 that can change a vertical position of the main body 110 relative to the table 104. The height adjustment mechanism 120 has a lifting handle 121 that can be rotated by the user, a rotation shaft 122 that is integrally formed with the lifting handle 121, and a lifting bolt 123 that is engaged with the rotation shaft 122. The base 102 has a main body support portion 131 that supports the main body 110 below the table 104. The rotation shaft 122 is inserted into the elongated hole 103a and passes through the base front side 103 in the front-back direction. The lifting handle 121 is located in front of the base front side 103. The lifting handle 121 and the rotation shaft 122 are rotatably supported by the main body support portion 131 around an axis of rotation extending in the front-back direction. A drive-side bevel gear 122a is provided at a rear end of the rotation shaft 122.

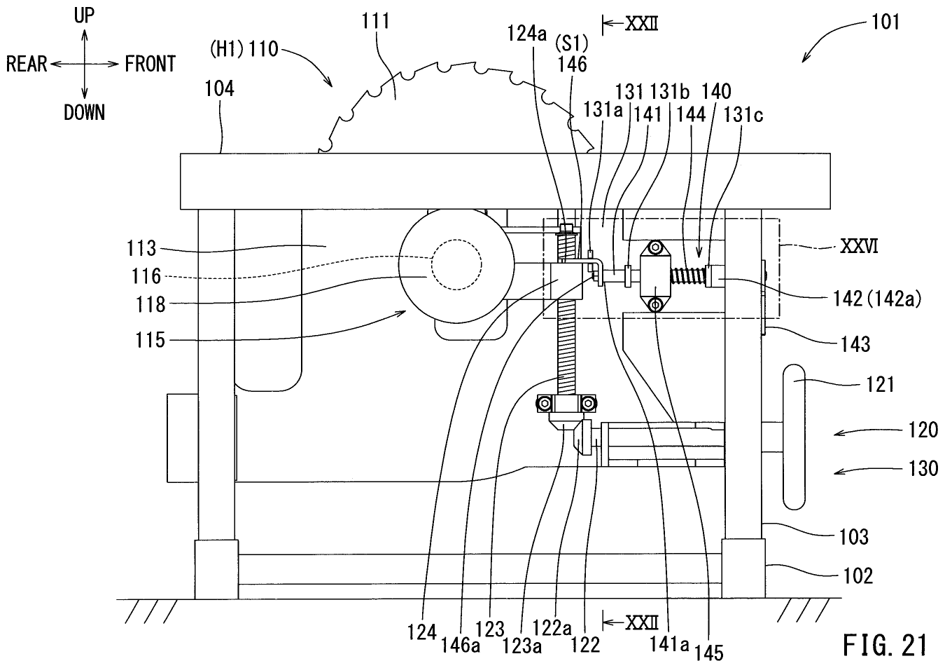

As shown in FIG. 21, the lifting bolt 123 is rotatably supported by the main body support portion 131 in a posture extending in the up-down direction. A driven-side bevel gear 123a is provided at a lower end of the lifting bolt 123. The driven-side bevel gear 123a engages the drive-side bevel gear 122a of the rotation shaft 122. When the rotation shaft 122 rotates around the axis extending in the front-back direction, the lifting bolt 123 rotates around the axis extending in the up-down direction. The main body 110 is provided with a lifting section 124 with a female thread that is screwed with the lifting bolt 123. The lifting section 124 moves in the up-down direction with respect to the lifting bolt 123 by rotating the lifting bolt 123 around its axis. This can change a length of the protrusion of the cutting blade 111 above the table 104.

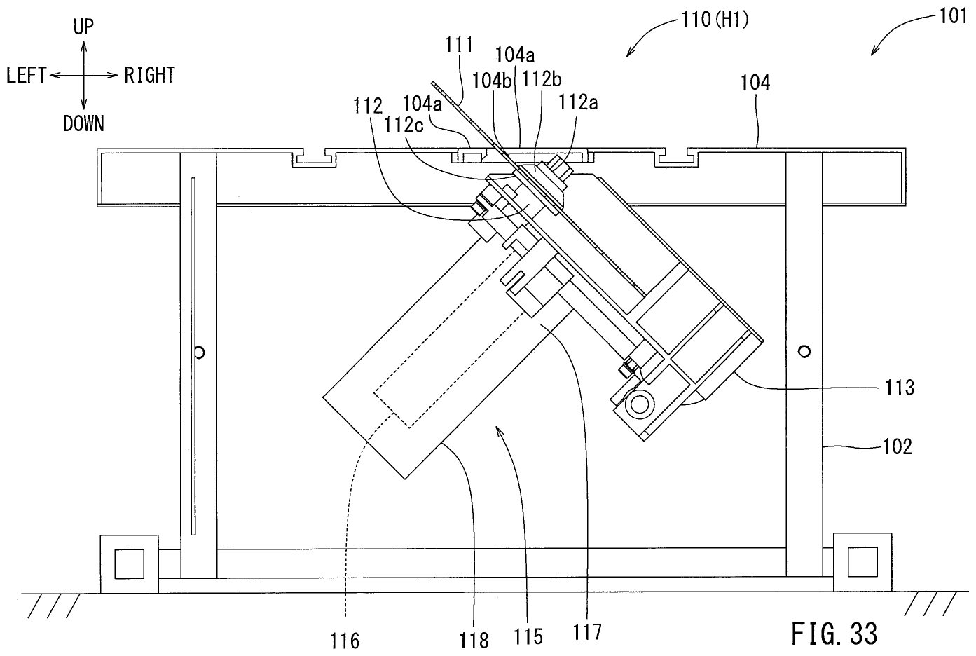

As shown in FIG. 31, the table saw 101 has an angle adjustment mechanism 130 that can change an inclination angle of the main body 110 with respect to a plane perpendicular to the table 104. The main body support portion 131 is supported by the base 102 so as to incline in the left-right direction. The user can grasp the lifting handle 121 to incline the main body support portion 131 to the left or right. When moving the lifting handle 121 in the left-right direction, the rotation shaft 122 moves to the left or right along the extending direction of the elongated hole 103a. By inclining the main body support portion 131 to the left or right with respect to the table 104, the main body 110 supported by the main body support portion 131 also inclines to the left or right with respect to the table 104. The inclination center of the main body 110 is a virtual center located on a top surface of the table 104. When the cutting blade 111 shown in FIG. 33 is inclined in a left-right direction with respect to a plane perpendicular to the table 104, the workpiece can be cut in a so-called bevel cut. The inclination angle of the cutting blade 111 shown in FIG. 33 with respect to the plane perpendicular to the table 104 is 45°.

As shown in FIG. 21, the table saw 101 has a stopper shaft 140 extending in the front-back direction. The stopper shaft 140 is provided in front of the lifting bolt 123 and above the rotation shaft 122. The stopper shaft 140 is provided with a height restriction mechanism to restrict the height of the main body 110, an inclination restriction mechanism to restrict the inclination angle of the main body 110, and a restriction maintaining mechanism to maintain the operation of the height restriction mechanism.

As shown in FIGS. 21, 23, and 24, the stopper shaft 140 has a round rod-shaped shaft body 141 extending in the front-back direction. A lift stopper 146 formed as a substantially L-shaped plate is attached to a tip 141a located at a rear end of the shaft body 141. The lift stopper 146 corresponds to a height restriction mechanism in the present disclosure. The lift stopper 146 can rotate relative to the shaft body 141 around its axis. The lift stopper 146 is prevented from falling off from the shaft body 141 by tightening a nut 146a on a tip 141a of the shaft body 141. The lift stopper 146 is inserted into the stopper support portion 131a provided in the main body support portion 131, thereby preventing the lift stopper 146 from rotating around the main body support portion 131. The main body support portion 131 is provided with a stopper receiving portion 131b protruding in front of the lift stopper 146. When the lift stopper 146 contacts the stopper receiving portion 131b, the forward movement of the lift stopper 146 is restricted.

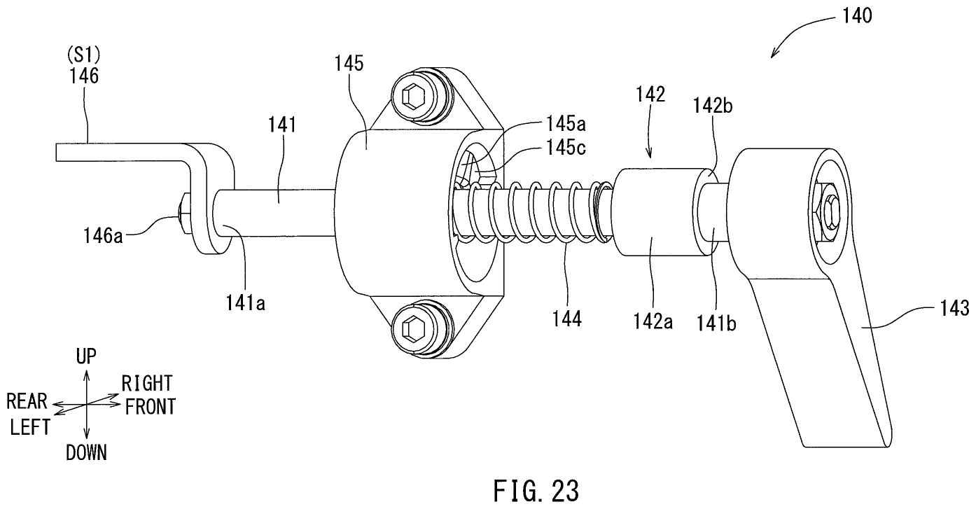

As shown in FIGS. 23, 24, and 26, a lever (operation portion) 143 is integrally attached to a shaft front 141b of the shaft body 141. The lever 143 is located in front of the base front side 103. When the user presses a side of the lever 143 with a finger, the shaft body 141 rotates around its axis. At the middle position of the shaft body 141 in the front-back direction, a round rod-shaped guide pin 141c is mounted perpendicularly to an axial direction of the shaft body 141. Each end of the guide pin 141c protrudes in a radial direction of the shaft body 141.

As shown in FIGS. 23, 24, and 26, a cylindrical intermediate portion 142 is attached to the shaft body 141. The intermediate portion 142 is attached behind the lever 143 and in front of the guide pin 141c. The intermediate portion 142 has a larger diameter than the shaft body 141. A lateral side 142a of the intermediate portion 142 corresponds to an inclination restriction mechanism in the present disclosure. The front side 142b of the intermediate portion 142 corresponds to a restriction maintaining mechanism in the present disclosure. A rear side of the intermediate portion 142 may contact an intermediate portion receiving portion 131c provided in the main body support portion 131. When the intermediate portion 142 contacts the intermediate portion receiving portion 131c, the rearward movement of the shaft body 141 is restricted. A compression spring (biasing member) 144 configured to bias the shaft body 141 backward is provided between the intermediate portion receiving portion 131c and the guide pin 141c in the front-back direction.

As shown in FIGS. 23, 24, and 26, the shaft body 141 is inserted to pass through a cylindrical lead portion 145 in the front-back direction. The lead portion 145 corresponds to a power conversion mechanism in the present disclosure. The lead portion 145 is integrally fixed to the body support portion 131. A pair of lead surfaces 145a extending spirally around the axis of the shaft body 141 to be inserted are formed on an inner circumference of the lead portion 145. The rear ends of the lead surfaces 145a communicate with a groove-like axial guide surface 145b that extends in the front-back direction and has a narrow width in the up-down direction. A pair of position-retaining portions 145c is provided that communicates with the front ends of the pair of lead surfaces 145a and is formed by planes substantially perpendicular to the shaft body 141. Distal ends of the guide pin 141c contact the lead surfaces 145a or the axial guide surface 145b. When the distal ends of the guide pin 141c are in contact with the lead surfaces 145a when the shaft body 141 rotates about its axis, the distal ends of the guide pin 141c move back and forth while being guided by the lead surfaces 145a in a spiral manner. This causes the entire shaft body 141 to move back and forth. When the guide pin 141c is in contact with the axial guiding surface 145b, the shaft body 141 is biased backward by a compression spring 144 while its rotation is restricted. The guiding action due to the inclination of the lead surfaces 145a does not work on the guide pin 141c when the guide pin 141c rides on and in contact with the front sides of the position retaining portions 145c. Therefore, the backward movement of the shaft body 141 is restricted.

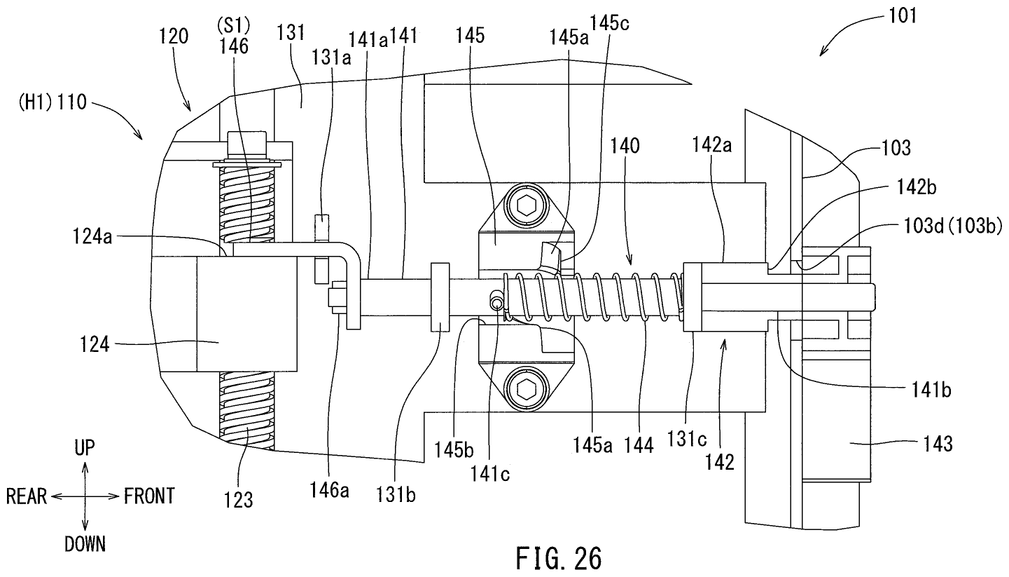

As shown in FIG. 26, the top surface of the lifting section 124 is provided as a flat stopper contact portion 124a. The lifting bolt 123 is formed with notches at the same up and down positions as the lift stopper 146. The lift stopper 146 can contact the stopper contact portion 124a while entering the notches in the lifting bolt 123 when the shaft body 141 moves backward. This regulates the upward movement of the main body 110 including the lifting section 124. The lift stopper 146 can be separated from the stopper contact portion 124a when the shaft body 141 moves forward. This releases the upward movement restriction of the main body 110 including the lifting portion 124.

The table saw 101 when the height restriction mechanism 146 is activated will be described with reference to FIGS. 22, 26 and 32 to 34. When the user rotates the lever 143 in a counterclockwise direction, the shaft body 141 and the guide pin 141c rotate in a counterclockwise direction around the axis of the shaft body 141. The distal ends of the guide pins 141c are guided to the lead surfaces 145a of the lead portion 145 and moves rearward while rotating in the counterclockwise direction. Furthermore, the distal ends of the guide pin 141c are guided to the axial guide surfaces 145b of the lead portion 145 to move rearward while being biased by the compression spring 144. At this time, the lateral side 142a of the intermediate portion 142 is located behind the elongated hole 103b of the base front side 103. The front side 142b of the intermediate portion 142 is located behind the base front side 103. The lift stopper 146 moves with the shaft body 141 to the rearward restricted position S1. The lift stopper 146 at the restricted position S1 contacts the stopper contact portion 124a of the lifting portion 124. As a result, the main body 110 is restricted from moving above the restricted height H1. Therefore, the main body 110 can move only in the area between the reference height, which is lower than the restricted height H1, and the restricted height H1, even if the lifting handle 121 is operated.

The height restriction mechanism 146 is operable independent of the inclination angle of the main body 110 with respect to a plane perpendicular to the table 104. For example, when the inclination angle of the main body 110 with respect to the plane perpendicular to the table 104 is 0° or 45°, the output shaft 112 including the nut 112a is located below the undersides of the table 104 and the blade edge plate 104a. Therefore, by restraining the height of the main body 110 to the restricted height H1, interference between the output shaft 112 and the table 104 may be prevented independent of the inclination angle of the main body 110 with respect to the plane perpendicular to the table 104.

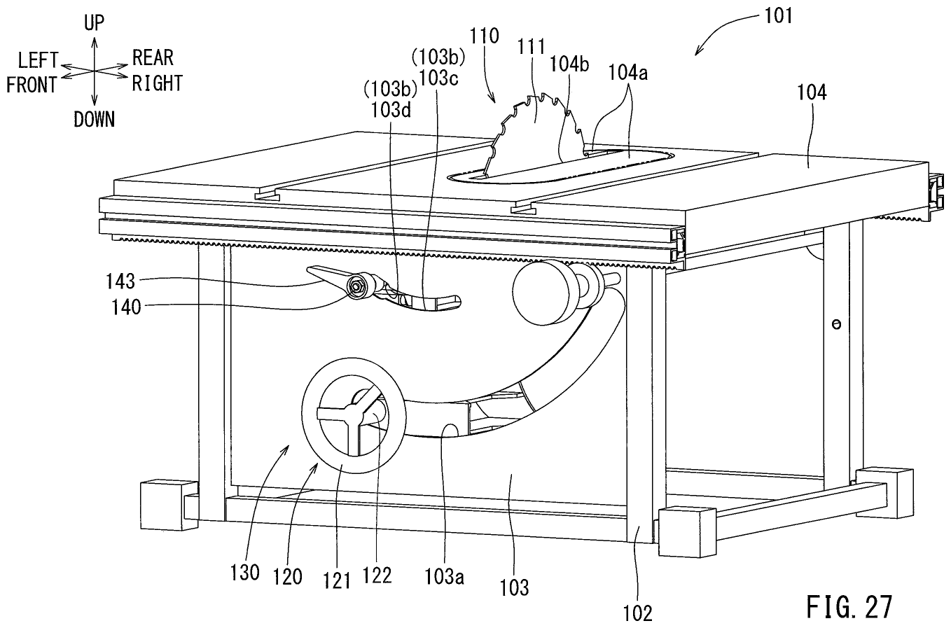

The table saw 101 when the height restriction mechanism 146 is deactivated and the inclination restriction mechanism 142a is activated will be described with reference to FIGS. 27-31. When the user rotates the lever 143 in a clockwise direction, the shaft body 141 and the guide pin 141c rotate in a clockwise direction around the axis of the shaft body 141. The distal ends of the guide pin 141c immediately enter the lead faces 145a from the axial guide faces 145b of the lead portion 145. The distal ends of the guide pin 141c are guided by the lead faces 145a to move forward against the biasing force of the compression spring 144. At this time, the lateral side 142a of the intermediate portion 142 enters the enlarged hole 103d of the base front side 103. The front side 142b of the intermediate portion 142 is positioned forward of the base front side 103. The lift stopper 146 moves with the shaft body 141 to the forward release position S2. The lift stopper 146 at the release position S2 is separated from the stopper contact portion 124a of the lifting portion 124. The main body 110 can therefore move to the limit-exceeding height H2, which is higher than the restricted height H1 (see FIG. 26). This allows the cutting depth of the cutting blade 111 to be deeper.

Only when the lateral side 142a of the intermediate portion 142 can enter the enlarged hole 103d, the lift stopper 146 can move to the release position S2. When the lateral side 142a of the intermediate portion 142 can enter the enlarged hole 103d, the inclination angle of the main body 110 with respect to the plane perpendicular to the table 104 is at a predetermined angle of 0°, for example, or within a predetermined angle range such as within ±1, ±3°, ±5°, etc. around 0°. When the inclination angle of the main body 110 with respect to the plane perpendicular to the table 104 is at the above-described predetermined angle or within the predetermined angle range, the output shaft 112 including the nut 112a is positioned below the undersides of the table 104 and the blade edge plate 104a while being inclined to the plane perpendicular to the table 104. Even when the main body 110 is moved up to the limit-exceeding height H2, interference between the output shaft 112 and the table 104 can be prevented. The lateral side 142a of the intermediate portion 142 that has entered the enlarged hole 103d is restricted from moving into the guide hole 103c, which has a smaller diameter than the intermediate portion 142. Therefore, changing the inclination angle of the main body 110 to an angle that exceeds the predetermined angle or the predetermined angle range is prevented.

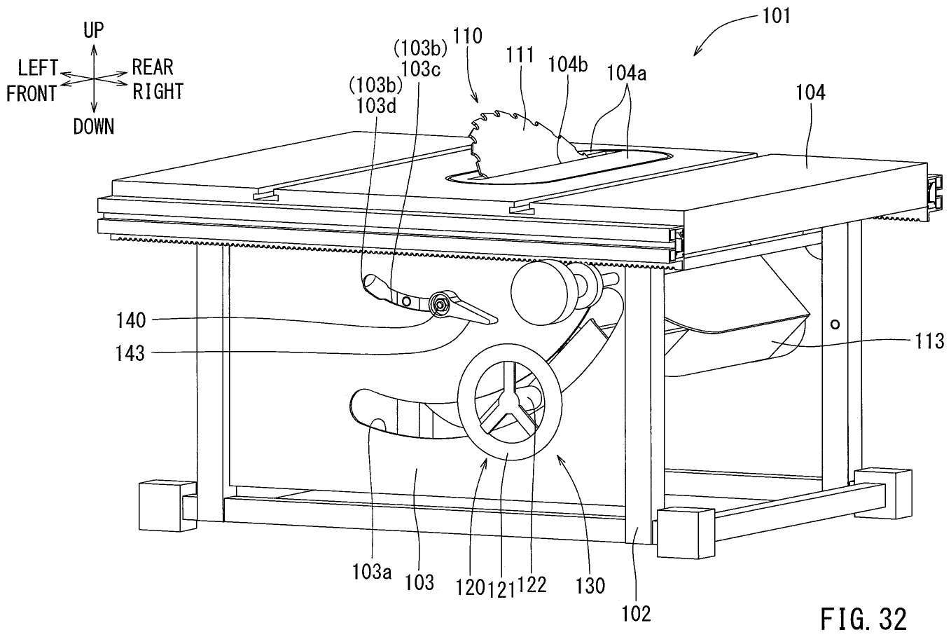

The table saw 101 with the restriction maintaining mechanism 142b activated will be described with reference to FIGS. 32, 33, and 35. When the inclination angle of the main body 110 with respect to the plane perpendicular to the table 104 is in a non-predetermined state that exceeds a predetermined angle or a predetermined angle range, for example, 30° or 45°, the user attempts to rotate the lever 143 in a clockwise direction. At this time, the rotational force of the shaft body 141 around the axis is converted to the power to move the shaft body 141 forward due to the engagement of the lead portion 145 and the guide pin 141c. However, the shaft front 141b of the shaft body 141 is removed from the enlarged hole 103d and inserted into the guide hole 103c. The front side 142b of the intermediate portion 142 is not allowed to enter the guide hole 103c even if it attempts to move forward and contacts the rear side of the base front side 103. Therefore, the forward movement of the shaft body 141 may be restricted.

The lift stopper 146 is restricted from moving forward from the restricted position S1. Therefore, the lift stopper 146 restricts the main body 110 from moving above the restricted height H1. To release the restriction maintaining mechanism 142b, the inclination angle of the main body 110 with respect to the plane perpendicular to the table 104 must be reduced to a predetermined state below the predetermined angle or within the predetermined angle range. When the inclination angle of the main body 110 with respect to the plane perpendicular to the table 104 is in a non-predetermined state exceeding the predetermined angle or the predetermined angle range and the height of the main body 110 is restricted by the restricted height H1, the output shaft 112 including the nut 112a is located below the undersides of the table 104 and the blade edge plate 104a. Therefore, the output shaft 112 and the table 104a are located below the underside of the table 104. Therefore, interference between the output shaft 112 and the table 104 may be prevented.

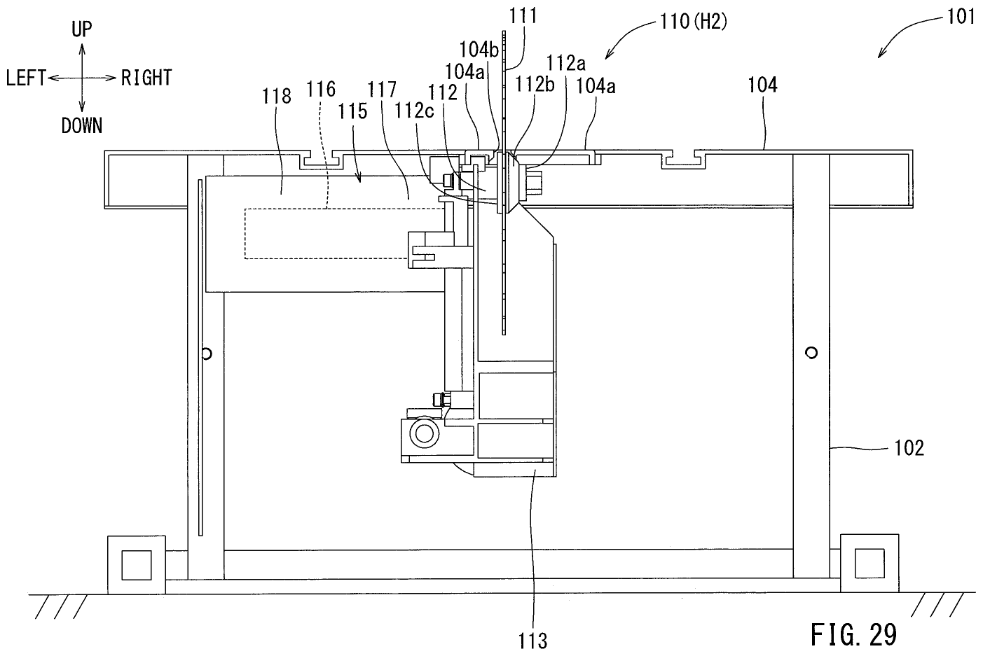

As described above, the table saw 101 has a table 104 on which the workpiece is placed as shown in FIG. 29. The table saw 101 has a main body 110 that is arranged below the table 104 and rotates a cutting blade 111 that penetrates the table 104. The table saw 101 has a height adjustment mechanism 120 that moves the main body 110 between a reference height and a limit-exceeding height H2 higher than the reference height to change the length of blade protrusion of the cutting blade 111 upward from the table 104. The table saw 101 has an angle adjustment mechanism 130 to change the inclination angle of the main body 110 with respect to a plane perpendicular to the table 104. The table saw 101 includes a lift stopper (height restriction mechanism) 146 that restricts the height adjustment mechanism 120 to restrict the upward movement of the main body 110 from the reference height to the restricted height H1 lower than the limit-exceeding height H2 when the inclination angle of the main body 110 is in a non-predetermined state in which the inclination angle of the main body is not at the predetermined angle or within the predetermined angle range.

Thus when the main body 110 is in a predetermined state (not a non-predetermined state), in which the inclination angle of the main body 110 is at the predetermined angle or within the predetermined angle range, the main body 110 is allowed to move upward to the limit-exceeding height H2. When the main body 110 is in the predetermined state, for example, the output shaft 112 that rotatably supports the cutting blade 111 is substantially parallel to the table 104. Therefore, the cutting depth of the cutting blade 111 may be deepened while the main body 110 and the table 104 do not interfere. When the main body 110 is in a non-predetermined state in which the inclination angle of the main body 110 is not at the predetermined angle or within the predetermined angle range, the main body 110 is maintained at the restricted height H1 such that the upward movement is restricted. When the main body 110 is in the non-predetermined state, the output shaft 112 that rotatably supports the cutting blade 111, for example, may be inclined with respect to the table 104. Therefore, by restricting the upward movement of the main body 110, interference of the inclined main body 110 with the table 104 can be restricted. Thus, the cutting depth of the cutting blade 111 can be deepened only when the inclination angle of the main body 110 is in the predetermined state, while the interference between the main body 110 and the table 104 is restricted regardless of the inclination angle of the main body 110.

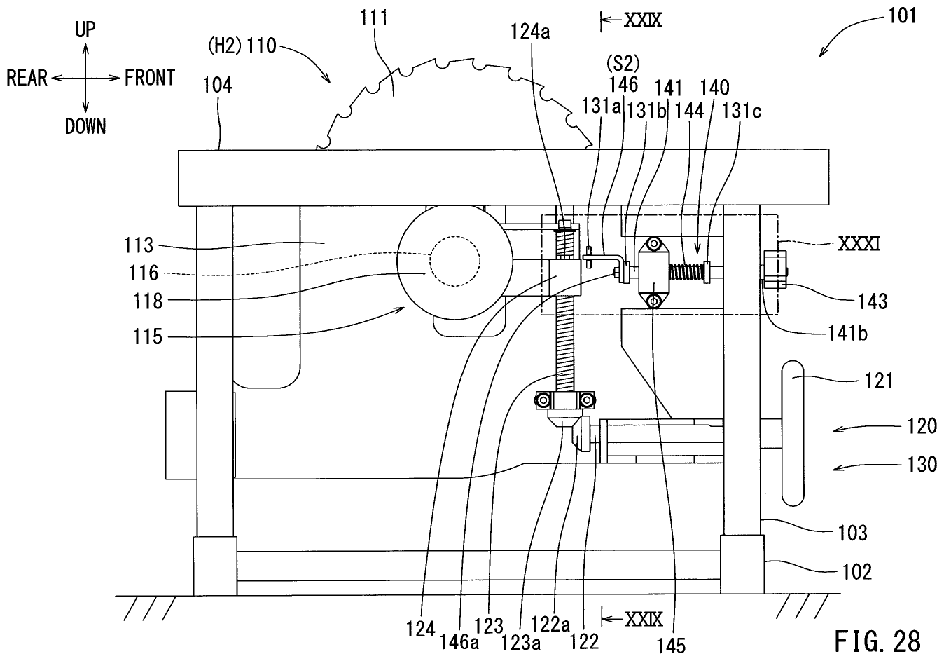

As shown in FIG. 28, the table saw 101 includes a lateral side (inclination restriction mechanism) 142a that restricts the inclination angle of the main body 110 to less than or equal to the predetermined angle or within the predetermined angle range when the lift stopper 146 is released to allow the main body 110 to move beyond the restricted height H1 (see FIG. 22) to the limit-exceeding height H2 Therefore, when the main body 110 moves to the limit-exceeding height H2, it is restricted to incline to the inclination angle of the non-predetermined state. Thus, the cutting depth can be deepened only when the inclination angle of the main body 110 is in the predetermined state. Moreover, the main body 110 at the limit-exceeding height H2 may be prevented from interfering with the table 104.

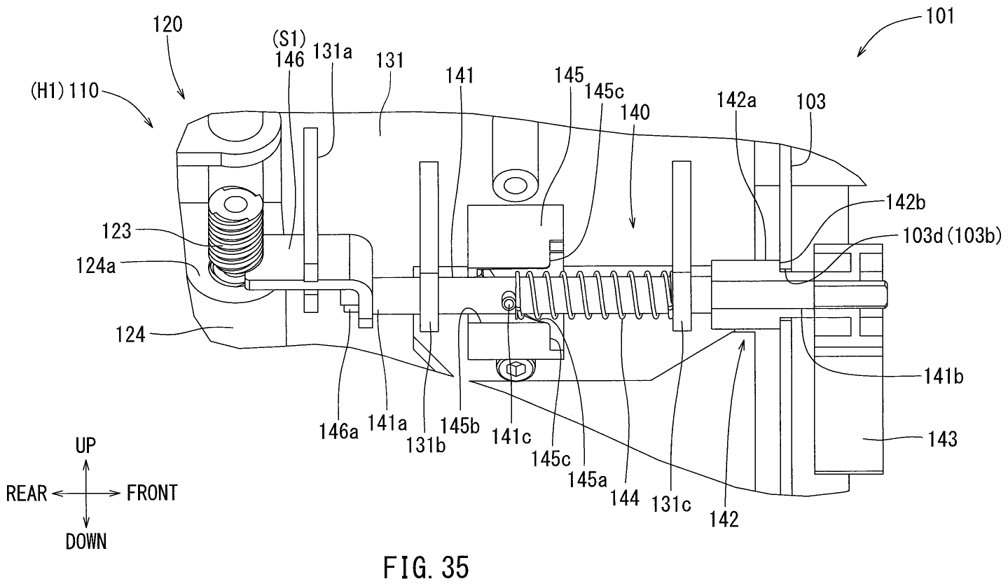

As shown in FIG. 35, the table saw 101 has a front side (maintaining restriction mechanism) 142b that always activates the lift stopper 146 when the main body 110 is in a non-predetermined state. Therefore, the main body 110 can be restricted from moving upward above the restricted height H1. This prevents the main body 110, which is inclined in the non-predetermined state, from interfering with the table 104 (see FIG. 33).

As shown in FIGS. 26 and 31, the height restriction mechanism has a stopper shaft 140 equipped with a lift stopper 146 at the tip 141a. By moving the stopper shaft 140 in the axial direction, the lift stopper 146 moves between a restricted position S1 above the stopper contact portion 124a of the height adjustment mechanism 120 and a release position S2 away from the stopper contact portion 124a. Therefore, the simply structured stopper shaft 140 and lift stopper 146 allows the height restriction mechanism to operate reliably.

As shown in FIGS. 26, 31, and 34, the table saw 101 has a base front side 103 formed with elongated hole 103b through which the stopper shaft 140 is inserted. The elongated hole 103b has an arc-shaped guide hole 103c and an enlarged hole 103d that communicates the guide hole 103c and has a larger diameter than the guide hole 103c (see FIG. 25). The stopper shaft 140 has a shaft main body 141 that enters the guide hole 103c and is guided along the guide hole 103c, and an intermediate portion 142 that is attached to the shaft main body 141 and has a diameter that is larger than the guide hole 103c and can be inserted into the enlarged hole 103d. The intermediate portion 142 enters the enlarged hole 103d and restricts the inclination angle of the main body 110 to a predetermined angle or within a predetermined angle range. Thus, the simply structured elongated hole 103b formed in the base front side 103 and an intermediate portion 142 provided in the stopper shaft 140 allows the inclination restriction mechanism 142a to operate reliably.

As shown in FIG. 35, when the inclination angle of the main body 110 is in a non-predetermined state, the intermediate portion 142 contacts the base front side 103 and is restricted from entering the guide hole 103c, thereby maintaining the operation of the lift stopper 146. Therefore, simply structured guide hole 103c formed in the base front side 103 and the intermediate portion 142 provided in the stopper shaft 140 allows the lift stopper 146 to operate reliably and to maintain its operation.

As shown in FIGS. 26 and 31, the table saw 101 has a lead portion (power conversion mechanism) 45 that converts a portion of rotational force of the stopper shaft 140 around the axis into a force of axial movement of the stopper shaft 140. Therefore, a simple operation to rotate the stopper shaft 140 around the axis allows the stopper shaft 146 to move in an axial direction and activate the lift stopper 146.

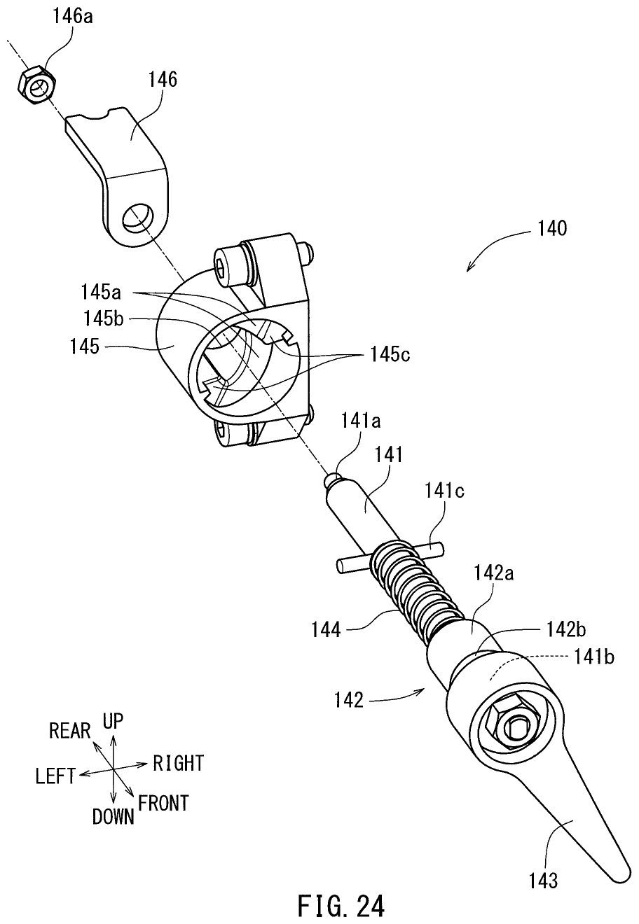

As shown in FIGS. 24, 26, and 31, the lead portion 145 has a lead surface 145a that extends spirally around the axis of the stopper shaft 140. Therefore, the force of rotation around the axis of the stopper shaft 140 can be efficiently converted into an axial movement force while controlling wear of the stopper shaft 140. This improves the operability of moving the stopper shaft 140 in the axial direction.

As shown in FIGS. 24, 26, and 31, the lead portion 145 includes a surface that communicates the lead surface 145a and extends in a direction different from the lead surface 145a and has a position-retaining portion 145c that restricts the axial movement of the stopper shaft 140. Therefore, the stopper shaft 140 and lift stopper 146 can be prevented from moving in the axial direction unintentionally. Furthermore, the lead surface 145a and the position-retaining portion 145c are communicated with each other, thereby allowing the stopper shaft 140 to easily switch between a state in which the stopper shaft 140 can move in the axial direction and a state in which the movement of the stopper shaft 140 is restricted.

As shown in FIGS. 26 and 31, the table saw 101 has a compression spring (biasing member) 144 that biases the stopper shaft 140 in the axial direction. Therefore, by constantly biasing the stopper shaft 140 and the lift stopper 146 in the axial direction, the lift stopper 146, which restricts the upward movement of the main body 110, can be prevented from being unintentionally released due to vibration or other reasons.

As shown in FIGS. 26, 31, 34 and 35, the stopper shaft 140 has a shaft front 141b that penetrates to the front of the base front side 103. A lever (operation portion) 43 for rotating the stopper shaft 140 around the axis is provided on the shaft front 141b. Thus, the lever 143 is provided in a position where the user can easily operate, thereby improving the operability of the lever 143.

As shown in FIGS. 26, 31, 34, and 35, the operation portion 143 is a lever that integrally rotates with the stopper shaft 140 around the axis of the stopper shaft 140. Therefore, the operation force to rotate the operation portion 143 can be reduced using the principle of leverage. This can improve the operability of the operation portion 143.

As shown in FIGS. 29 and 31, the table saw 101 has an output shaft 112 that is provided on the main body 110 and rotatably supports a disk-shaped cutting blade 111. The table saw 101 has a lateral side (inclination restriction mechanism) 142a that restricts the inclination angle of the main body 110 to a predetermined state in which the inclination angle is at a predetermined angle or within a predetermined angle range. The output shaft 112 can move further upward when the lateral side 142a is released than when the lateral side 142a is operated. Therefore, when the inclination angle of the main body 110 is in the non-predetermined state, the output shaft 112 can be prevented from interfering with the table 104. The cutting depth of the cutting blade 111 can be deepened only when the inclination angle of the main body 110 is in the predetermined state.

As shown in FIGS. 26 and 31, the height restriction mechanism 146 has a stopper shaft 140 that moves in an axial direction and releasably engages the height adjustment mechanism 120. The stopper shaft 140 restricts the inclination angle of the main body 110 when it moves in the axial direction and is disengagement from the height adjustment mechanism 120. Therefore, a single operation to move the stopper shaft 140 in the axial direction can simultaneously disengage the lift stopper 146 and restrict the inclination angle of the main body 110.

Various modifications may be made to the table saw 101 according to the present example described above. Instead of the tipped cutting saw blade 111, a stacked dado set with a larger axial thickness may be mounted on the output shaft 112. The length of the rightward extension of the output shaft 112 is longer to allow mounting of the stacked dado set. However, by restricting the upward movement of the main body 110 to the restricted height H1 as shown in this example, interference between the output shaft 112 and the table 104 may be sufficiently prevented even when the output shaft 112 is inclined to the table 104.

A configuration to provide the lifting handle 121 and lever 143 in front of the base front face 103 has been exemplary described. Alternatively, the lifting handle 121 and lever 143 may be provided, for example, at the rear or right and left sides of the base 102. The lever 143 may be modified, for example, to have a handle shape that can be rotated and operated.

The predetermined state of the main body 110 has been defined by an inclination angle of 0° with respect to a plane perpendicular to the table 104, or a range of predetermined angles centered at an inclination angle of 0°. The predetermined angle shall not be limited to the 0° as described in the examples, but may be changed to −5°, −1, +1°, +5°, etc. as appropriate. The width of the predetermined angle range shall not be limited to that described in the example, but may be changed as appropriate, for example, to within ±10°, ±15°, etc., as long as the output shaft 112 does not interfere with the table 104 when the main body 110 is moved to the limit-exceeding height H2.

For example, to restricting unintentional movement of the stopper shaft 140 due to the biasing force of the compression spring 144, a convex portion protruding inwardly on the inner circumference of the lead portion 145 may be provided as the position-retaining portion 145c. A position of the guide pin 141c in the front-back position may be determined as the guide pin 141c passes over the convex portion.

The various examples described in detail above, with reference to the attached drawings, are intended to be representative of the present disclosure, and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, so as to provide an improved table saw, and/or methods of making and using the same.

What is claimed is:

1. A table saw comprising:
a table for placing a workpiece;
a main body disposed below the table having a motor;
a cutting blade connected to the motor, the cutting blade penetrating the table in an up-down direction; and
a movable mechanism for the cutting blade to be movable along with the main body with respect to the table, wherein the movable mechanism is configured to adjust a height of the main body with respect to the table, and an angle of the main body with respect to the table.

2. The table saw according to claim 1, wherein the movable mechanism has a guide mechanism configured to tilt the cutting blade along with the main body with respect to the table, and to move a center of the cutting blade downward and away from the table when an upper end of the cutting blade is movably closer to the table so that the upper end of the cutting blade moves to a first side and the center of the cutting blade moves to a second side opposite to the first side.

3. The table saw according to claim 2, wherein the guide mechanism further includes
a first link configured to connect the table to the main body, and
a second link disposed on the first side with respect to the first link, and wherein the second link is configured to connect the table and the main body.

4. The table saw according to claim 3 further comprising:
a first body-side shaft configured to rotatably connect the first link to the main body,
a first table-side shaft configured to rotatably connect the first link to the table,
a second body-side shaft configured to rotatably connect the second link to the main body, and
a second table-side shaft configured to connect the second link to the table,
wherein the first body-side shaft is located farther away from an intersection area of the cutting blade and the table than the first table-side shaft, and
wherein the second body-side shaft is located farther away from the intersection area than the second table-side shaft.

5. The table saw according to claim 3 further comprising:
a first body-side shaft configured to rotatably connect the first link to the main body,
a first table-side shaft configured to rotatably connect the first link to the table,
a second body-side shaft configured to rotatably connect the second link to the main body, and
a second table-side shaft configured to connect the second link to the table,
wherein a distance between the first body-side shaft and the second body-side shaft is greater than a distance between the first table-side shaft and the second table-side shaft.

6. The table saw according to claim 3, wherein the second link is configured to be longer than the first link for decreasing a length of blade protrusion when a tilt angle of the cutting blade increases.

7. The table saw according to claim 3, wherein at least a part of the first link or the second link is disposed between the cutting blade and the motor for enhancing a stability of the main body.

8. The table saw according to claim 3 further comprising a lifting shaft supported by the table for guiding the main body in a direction parallel to the cutting blade, wherein at least a part of the first link or the second link is disposed between the cutting blade and the lifting shaft for maintaining a rigidity of the main body when an external force applies on the cutting blade.

9. The table saw according to claim 3, wherein:
the guide mechanism further includes a guide member supported by the table for guiding the main body in a direction that is movable by the first link and the second link, and
the motor is disposed between the first link and the guide member in the front-back direction along which the cutting blade is extendable.

10. The table saw according to claim 3 further comprising a lifting shaft supported by the table for guiding the main body in a direction parallel to the cutting blade,
wherein the guide mechanism further includes a guide member supported by the table for guiding the main body in a direction that is movable by the first link and the second link, and
wherein the lifting shaft is disposed between the first link and the guide member in a front-rear direction along which the cutting blade is extendable.

11. The table saw comprising:
a table for placing a workpiece;
a main body disposed below the table having a motor;
a cutting blade connected to the motor, the cutting blade penetrating the table in an up-down direction;
a movable mechanism for the cutting blade to be movable along with the main body with respect to the table, wherein the movable mechanism is configured to adjust a height of the main body with respect to the table, and an angle of the main body with respect to the table;
a link configured to connect the table to the main body;
a screw for loosing and tightening the table; and
a link support releasably fixed to the table and connected to the link, wherein the link support is formed with an elongated hole penetrating in the up-down direction for the screw to be fitted in.

12. The table saw according to claim 2, wherein a length of protrusion of the cutting blade in a direction parallel to the cutting blade decreases when a tilt angle of the cutting blade with respect to a plane perpendicular to the table increases, wherein the length of protrusion decreases more when the tilt angle decreases, and wherein the length of decrease reduces less when the tilt angle increases.

13. A table saw comprising:
a table for placing a workpiece;
a main body disposed below the table having a motor;
a cutting blade connected to the motor, the cutting blade penetrating the table in an up-down direction;
a height adjustment mechanism configured to move the main body between a reference height and a limit-exceeding height higher than the reference height to change a length of blade protrusion upward from the table,
an angle adjustment mechanism configured to change an inclination angle of the main body with respect to a plane perpendicular to the table, and
a height restriction mechanism configured to restrict the height adjustment mechanism to restrict an upward movement amount of the main body from the reference height to a restricted height lower than the limit-exceeding height, wherein the inclination angle of the main body is in a non-predetermined state, in which the inclination angle of the main body is not at a predetermined angle or within a predetermined angle range.

14. The table saw according to claim 13 further comprises an inclination restriction mechanism configured to restrict the inclination angle of the main body to less than or equal to the predetermined angle or within the predetermined angle range when the height restriction mechanism is released for the main body to move beyond the restricted height to the limit-exceeding height.

15. The table saw according to claim 13 further comprises a restriction maintaining mechanism configured to activate the height restriction mechanism when the main body is in a non-predetermined state.

16. The table saw according to claim 13, wherein the height restriction mechanism further has a stopper shaft including a lift stopper at a tip of the stopper shaft and configured to be movable in an axial direction, wherein the lift stopper is movable between a restricted position located above a stopper contact portion of the height adjustment mechanism and a release position away from the stopper contact portion.

17. The table saw according to claim 16 further comprising a base front side formed with an elongated hole for inserting the stopper shaft, wherein
the elongated hole has a guide hole with an arc-shape and an enlarged hole that communicates to the guide hole and has a larger diameter than the guide hole,
the stopper shaft includes a shaft main body that enters the guide hole and is guided along the guide hole, and an intermediate portion that is attached to the shaft main body and has a diameter that is larger than the guide hole and is allowed to be inserted into the enlarged hole, and
the intermediate portion enters the enlarged hole and restricts the inclination angle of the main body to the predetermined angle or within the predetermined angle range.

18. The table saw according to claim 17, wherein the intermediate portion is in contact with the base front side and is restricted from entering the guide hole when the inclination angle of the main body is in the non-predetermined state for maintaining an operation of the height restriction mechanism.

19. The table saw according to claim 16 further comprises a power conversion mechanism configured to convert a portion of rotational force of the stopper shaft around an axis into a force of axial movement of the stopper shaft.

20. The table saw according to claim 19, wherein the power conversion mechanism has a lead surface extending spirally around the axis of the stopper shaft.
